(19) United States
(12) Patent Application Publication
(10) Pub. No.: US 2025/0051552 A1
(43) Pub. Date: Feb. 13, 2025

(54) MATERIAL AND ITS USE IN TRIBOELECTRIC NANOGENERATOR

(71) Applicant: CITY UNIVERSITY OF HONG KONG, Kowloon (HK)

(72) Inventors: Xiangkun BO, Kowloon (HK); Walid A. DAOUD, Kowloon (HK); Weilu LI, Kowloon (HK); Hong ZHAO, Kowloon (HK)

(73) Assignee: CITY UNIVERSITY OF HONG KONG, Kowloon (HK)

(21) Appl. No.: 18/750,593

(22) Filed: Jun. 21, 2024

Related U.S. Application Data
(60) Provisional application No. 63/517,955, filed on Aug. 7, 2023.

(51) Int. Cl. C08L 1/28; B82Y 30/00; H02N 1/04

(52) U.S. Cl. CPC C08L 1/286; H02N 1/04; B82Y 30/00; C08L 2203/20; C08L 2207/32; C08L 2666/34; C08L 2666/54

(57) ABSTRACT

A material for triboelectric nanogenerator comprising a biomass-based material co-doped with a hygroscopic agent and a metal salt, wherein: the biomass-based material includes any one of a saccharide-based material; the hygroscopic agent includes any one of a polyol-based compound, a sulfone-based compound, a tetrahydropyran-based, or a isocyanate-based compound; and the metal salt includes any one of a monovalent metal salt, a divalent metal salt or a trivalent metal salt. Use of the material in a triboelectric nanogenerator is also addressed.

### CROSS-REFERENCE TO RELATED APPLICATIONS

This application claims the benefit of U.S. Provisional Application No. 63/512,869, filed Jul. 10, 2023, the content of which application is hereby incorporated by reference in its entirety.

### TECHNICAL FIELD

The present invention relates to a material, for example, particularly, but not exclusively, a triboelectric material such as a tribo-positive material for triboelectric nanogenerator and use of the material in triboelectric nanogenerator.

### BACKGROUND OF THE INVENTION

It is believed that triboelectric nanogenerator (TENG) is one of the promising devices for use in wearable electronics since TENG converts mechanical energy to electricity. Typically, in the process of contact-separation of the device, charges are transferred from the positive tribolayer to the negative tribolayer and thus opposite charges are inducted on the electrodes, which in turn generates electricity. Given that TENG is generally portable, safe, and structurally simple, it is easily integrated into clothing. Thus, it is believed that TENG holds an immense potential in the field of energy harvesting from the motion of human body.

In a typical TENG configuration, the tribolayer (or triboelectric layer) and the electrode each has different functions, with the tribolayer having good charge-denoting or charge-trapping ability and the electrode having a good conductivity. It is therefore believed that both of the tribolayer and the electrode are required for the TENG to function. However, the tribolayer and the electrode may have different mechanical strength and may easily delaminate under repeated stretching-releasing and other deformation wear conditions. Thus, there is a strong need for the development of bifunctional materials for TENG.

The present invention thus seeks to eliminate or at least mitigate such shortcomings by providing a new or otherwise improved material, such as a biomass-based material for TENG.

### SUMMARY OF THE INVENTION

In a first aspect of the present invention, there is provided a material for triboelectric nanogenerator comprising a biomass-based material co-doped with a hygroscopic agent and a metal salt, wherein: the biomass-based material includes any one of a saccharide-based material; the hygroscopic agent includes any one of a polyol-based compound, a sulfone-based compound, a tetrahydropyran-based, or a isocyanate-based compound; and the metal salt includes any one of a monovalent metal salt, a divalent metal salt or a trivalent metal salt.

In an optional embodiment, the saccharide-based material comprises sodium alginate, lignin, cellulose, starch, sodium lignosulfonate, sodium carboxymethylcellulose, Arabic gum, maltose, glucose, natural resin, and chitin.

Optionally, the natural resin includes polyurethane resin and acrylic resin.

It is optional that the hygroscopic agent includes at least one of:

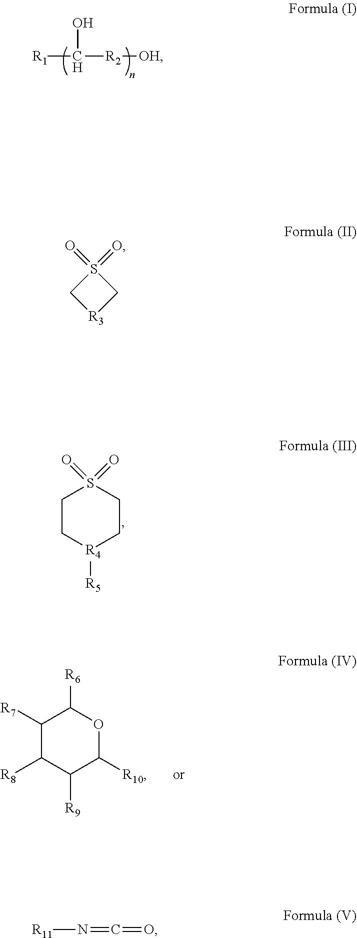

wherein: n is positive integer; R₁ and R₂ are independently selected from hydrogen, an alkyl group, hydroxyl group, hydroxyalkyl group, carbonyl group, alkylcarbonyl group, sulfhydryl group, or amino group; R₃ is selected from an alkyl group, alkoxy group, hydroxyalkyl group, alkylmercapto group, alkylamino group, or alkyl sulfone group, with 1-10 carbon atoms; R₄ is a nitrogen or sulfur element; R₅ is a hydroxyl group, sulfhydryl group or amino group; R₆, R₇, R₈, R₉ and R₁₀ are independently selected from an alkyl group, hydroxyl group, hydroxyalkyl group, a sulfhydryl group or an amino group, with 1-10 carbon atoms; and R₁₁ is selected from an alkyl group, hydroxyl group, hydroxyalkyl group, isocyanate, alkyl isocyanate, sulfhydryl group or amino group, with 1-10 carbon atoms.

In an optional embodiment, the hygroscopic agent of Formula (I) is selected from the group consisting of glycerol, ethylene glycol, butylene glycol (such as, in particular, 1,2-butanediol), glyoxylic acid monohydrate and a combination thereof.

Optionally, the hygroscopic agent of Formula (II) and Formula (III) are selected from the group consisting of:

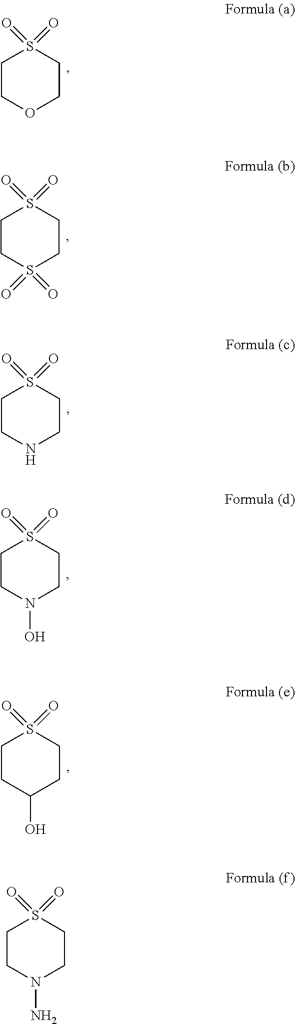 [SMILES: O=S1(=O)CCOCC1 ; O=S1(=O)CCS(=O)(=O)CC1 ; O=S1(=O)CCNCC1 ; O=S1(=O)CCN(O)CC1 ; O=S1(=O)CCC(O)CC1 ; NN1CCS(=O)(=O)CC1]

and a combination thereof.

It is optional that the hygroscopic agent of Formula (IV) is selected from the group consisting of:

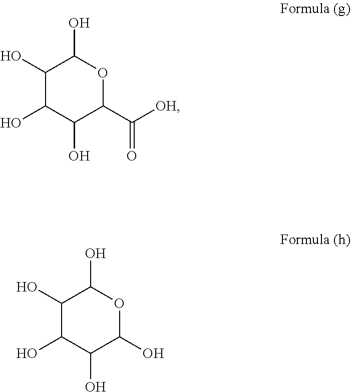 [SMILES: O=C(O)C1OC(O)C(O)C(O)C1O ; OC1OC(O)C(O)C(O)C1O]

and a combination thereof.

Optionally, the hygroscopic agent of Formula (V) is selected from the group consisting of:

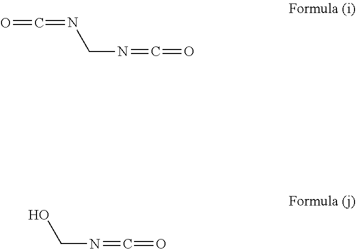 [SMILES: O=C=NCN=C=O ; O=C=NCO]

and a combination thereof.

Optionally, weight ratio of the hygroscopic agent to the biomass-based material is from about 1:5 to about 2:1.

It is optional that the metal salt includes halide, nitrate, sulfate, carbonate, sulfite, hydroxide, borate, oxalate, difluorooxalatoborate, bisoxalate borate, phosphate, fluorosulfonimide, alkylfluorosulfonimide, sulfonate, alginate, lignosulfonate or carboxymethyl cellulose of lithium, calcium, iron(II), iron(III), copper(II), cobalt(II) or zinc(II).

Optionally, the metal salt is selected from any one of zinc(II) bisoxalate borate, lithium bisoxalate borate, zinc(II) dimethylfluorosulfonimide, lithium dimethylfluorosulfonimide, calcium chloride, copper(II) chloride, zinc(II) chloride, cobalt(II) chloride, iron(III) chloride, iron(II) sulfate, copper(II) sulfate or zinc(II) sulfate.

It is optional that weight ratio of the metal salt to the biomass-based material is from about 1:100 to about 1:25.

In an optional embodiment, the biomass-based material is selected from the group consisting of sodium alginate, sodium lignosulfonate, sodium carboxymethylcellulose and a combination thereof; the hygroscopic agent is selected from the group consisting of glycerol, glyoxylic acid monohydrate, Formula (c), Formula (e), Formula (f), Formula (g), Formula (h), Formula (i), Formula U) and a combination thereof; the metal salt is selected from the group consisting of zinc(II) chloride, copper(II) chloride and a combination thereof.

Optionally, the biomass-based material is sodium alginate or sodium lignosulfonate; the hygroscopic agent is selected from the group consisting of glyoxylic acid monohydrate, Formula (c), Formula (e), Formula (f), Formula (g), Formula (h), Formula (i), Formula U) and a combination thereof; the metal salt is zinc(II) chloride or copper(II) chloride.

It is optional that the biomass-based material is sodium carboxymethylcellulose; the hygroscopic agent is glycerol; and the metal salt is copper(II) chloride.

Optionally, the material is a tribo-positive material.

In a second aspect of the present invention, there is provided a triboelectric nanogenerator comprising: a first member including a tribo-positive layer of the material in accordance with the first aspect and a positive electrode; a second member including a tribo-negative layer and a negative electrode; the first and second members are spatially separated from one another thereby permits relative movement of the first member and the second member for generating a potential difference between them as a result of triboelectrification effect.

In an optional embodiment, the triboelectric nanogenerator further comprises a separating member configured to maintain the spatial separation between the first member and the second member.

Optionally, the separating member is deformable. It is optional that the separating member includes any one of foam, rubber or spring.

In an optional embodiment, the tribo-negative layer includes any one of polytetrafluoroethylene, fluorinated ethylene propylene, silicon rubber (i.e. Ecoflex), polydimethylsiloxane, polyvinyl chloride, or polyvinyl alcohol.

In an optional embodiment, the triboelectric nanogenerator further comprises a first substrate and a second substrate to each of which the first member and the second member are attached.

In an optional embodiment, the second substrate is configured to act as another tribo-negative layer thereby permits charge transfer to occur between the second substrate and a standalone tribo-positive material.

Optionally, the standalone tribo-positive material includes a body part of a living subject.

In an optional embodiment, the first substrate and the second substrate are integrated to form an encapsulation encapsulating the triboelectric nanogenerator.

Optionally, the first substrate and the second substrate include any one of polyethylene terephthalate or silicon rubber.

In an optional embodiment, the positive electrode and the negative electrode have different materials.

Optionally, the positive electrode has the same material as the tribo-positive layer and is integrated with the tribo-positive layer to form a single layer.

Optionally, the negative electrode has the same material as the tribo-negative layer and is integrated with the tribo-negative layer to form a single layer.

In an optional embodiment, the positive electrode and the negative electrode have the same material.

Optionally, the positive electrode and the negative electrode include Ni/Ag conductive tape.

In an optional embodiment, the positive electrode and the negative electrode have the same material as the tribo-positive layer.

It is optional that the positive electrode is integrated with the tribo-positive layer to form a single layer.

Optionally, the spatial separation between the first member and the second member is from about 3 mm to about 10 mm.

It is optional that the triboelectric nanogenerator is bendable away from a horizontal plane by about 300 to about 90°.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1A is a table summarizing the mechanical and electrical performance of biomass-based triboelectric materials 1-20 and their triboelectric nanogenerators;

FIG. 1B is a table summarizing the mechanical and electrical performance of biomass-based triboelectric materials 21-38 and their triboelectric nanogenerators;

FIG. 1C is a table summarizing the mechanical and electrical performance of comparative biomass-based triboelectric materials 1-7 and their triboelectric nanogenerators;

FIG. 2 is a schematic diagram illustrating the fabrication of SC, SCG and SCGC (top), and the electron transfer from SC, SCG-0.50, and SCGC-0.2 to fluorinated ethylene propylene (FEP) (bottom);

FIG. 3 is a series of photos of, from left to right, SC, SCG-0.25, SCG-0.50, SCG-0.75, SCGC-0.1, SCGC-0.2 and SCGC-0.3;

FIG. 4 shows the transmittance of SC film, SCG films, and SCGC films of 0.5 mm thickness;

FIG. 5A shows the elemental distribution of, from left to right, SCGC-0.2, C, O, Na, Cl, and Cu;

FIG. 5B shows the surface morphology of SC, SCG-0.50 and SCGC-0.2;

FIG. 6A shows the tensile stress-strain curves of SC and SCG films. The inset shows enlarged tensile strength-strain curves of SCG-0.5 and SCG-0.75;

FIG. 6B shows the tensile strength-strain curves of SCG-0.50 and SCGC films;

FIG. 6C shows the water retention of SC, SCG, and SCGC films after drying at different temperatures;

FIG. 7 shows the FTIR curves of SC, SCG films and SCGC films;

FIG. 8 shows the SC, SCG, and SCGC films drying at different temperatures;

FIG. 9 shows the surface potential of SC, SCG-0.50 and SCGC-0.2;

FIG. 10 is a schematic diagram illustrating the mechanism of electron transfer from SCGC-0.2 to FEP;

FIG. 11 is a schematic diagram illustrating the EIS setup for measuring the dielectric constants of the SC, SCG and SCGC films;

FIG. 12A shows the dielectric constant of the SC and SCG films;

FIG. 12B shows the dielectric constant of the SCGC films;

FIG. 13 is a schematic diagram illustrating the device structure of the two-electrode TENG;

FIG. 14A is a schematic diagram illustrating the working mechanism of the two-electrode TENG;

FIG. 14B shows the current signal of the two-electrode TENG during the press-release process;

FIG. 15A shows the V_{OC} of the SC and SCG films;

FIG. 15B shows the Q_{SC} of the SC and SCG films;

FIG. 15C shows the I_{SC} of the SC and SCG films;

FIG. 16A shows the V_{OC} of the SCG-0.50 and SCGC films;

FIG. 16B shows the Q_{SC} of the SCG-0.50 and SCGC films;

FIG. 16C shows the I_{SC} of the SCG-0.50 and SCGC films;

FIG. 17 is a table summarizing the mechanical properties, conductivity, and electric output of various biomass-based triboelectric materials;

FIG. 18 shows the Q_{SC} density of SC, SCG-0.50 and SCGC-0.2 based two-electrode TENGs;

FIG. 19 shows the mass retention of SCGC-0.2 stored at 60% RH for 6 months;

FIG. 20 shows the V_{OC} of SCGC-0.2 cycling over 2000 seconds;

FIG. 21 shows the V_{OC} of SCGC-0.2-based two-electrode TENG at frequency ranging from 0.5 Hz to 10 Hz;

FIG. 22 shows the current density of SCGC-0.2-based two-electrode TENG at frequency ranging from 0.5 Hz to 10 Hz;

FIG. 23A shows the location of FEP, Ecoflex (i.e. silicon rubber), PET, PDMS, Nylon 66 and SCGC-0.2 in the triboelectric series;

FIG. 23B shows the V_{OC} of SCGC-0.2-based two-electrode TENG with different tribo-negative counterparts;

FIG. 23C shows the I_{SC} of SCGC-0.2-based two-electrode TENG with different tribo-negative counterparts;

FIG. 24 shows the comparison of electric output, elongation at break and conductivity of SC, SCG-0.50 and SCGC-0.2;

FIG. 25 shows the comparison of charge density between reported device and the device in this work;

FIG. 26A shows a photo of the electric circuit connection of LEDs and a rectifier;

FIG. 26B shows a photo of lighting 280 LEDs powered by SCGC-0.2-based two-electrode TENG with the dimension of 2×2 cm²;

FIG. 26C shows a photo (left) of the electric circuit connection of 0.5 W bulbs and a rectifier, and a photo (right) of lighting 92 0.5 W of bulbs powered by SCGC-0.2-based two-electrode TENG with the dimension of 2×2 cm²;

FIG. 27A shows the voltage and current of the SCGC-0.2-based two-electrode TENG with the loading resistance from 1000 to 500,000,000Ω at the working speed of 0.2, 0.4 and 0.6 m s⁻¹ respectively;

FIG. 27B shows the power density of the SCGC-0.2-based two-electrode TENG with the loading resistance from 1000 to 500,000,000Ω at the working speed of 0.2, 0.4 and 0.6 m s⁻¹, respectively. Inset shows the electric circuit used in measuring power density;

FIG. 28 shows the charging of 0.47, 1.0, 4.7 and 10 F capacitors by the SCGC-0.2-based two-electrode TENG;

FIG. 29A is a schematic diagram illustrating the EIS setup for measuring the ionic conductivity of SC, SCG-0.50, SCGC-0.1, SCGC-0.2 and SCGC-0.3 films;

FIG. 29B shows the EIS curves of SC and the electric circuit used;

FIG. 29C shows the EIS curves of SCG-0.50 and the electric circuit used;

FIG. 29D shows the EIS curves of SCGC-0.1 and the electric circuit used;

FIG. 29E shows the EIS curves of SCGC-0.2 and the electric circuit used;

FIG. 29F shows the EIS curves of SCGC-0.3 and the electric circuit used;

FIG. 30 shows the ionic conductivity of SC, SCG-0.50, SCGC-0.1, SCGC-0.2 and SCGC-0.3 films;

FIG. 31 is a schematic diagram illustrating the device structure of the conductive tape-based one-electrode TENG (upper device) and SCGC-0.2-based one-electrode TENG (bottom device);

FIG. 32A shows the V_{OC} of the conductive tape-based and SCGC-0.2-based one-electrode devices;

FIG. 32B shows the Q_{SC} of the conductive tape-based and SCGC-0.2-based one-electrode devices;

FIG. 32C shows the I_{SC} of the conductive tape-based and SCGC-0.2-based one-electrode devices;

FIG. 33A is a schematic diagram illustrating the device surface condition at low and high RH;

FIG. 33B shows the V_{OC} of the SCGC-0.2-based TENG at RH ranging from 10% to 90%;

FIG. 33C shows the Q_{SC} of the SCGC-0.2-based TENG at RH ranging from 10% to 90%;

FIG. 33D shows the I_{SC} of the SCGC-0.2-based TENG at RH ranging from 10% to 90%;

FIG. 34 is a schematic diagram illustrating the device structure of the single electrode TENG tied on a finger;

FIG. 35A is a schematic diagram illustrating the working mechanism of the single electrode TENG tied on a finger;

FIG. 35B shows the photos which illustrate the energy harvesting process when the finger is subjected to bending-releasing at different bending angles;

FIG. 36A shows the V_{OC} of the energy harvested from finger bending-releasing at different bending angles;

FIG. 36B shows the Q_{SC} of the energy harvested from finger bending-releasing at different bending angles;

FIG. 36C shows the I_{SC} of the energy harvested from finger bending-releasing at different bending angles;

FIG. 37 is a schematic diagram illustrating the structure of the SCGC-0.2-based sealed multilayer TENG in operation;

FIG. 38A shows the photos of a finger (left) and a hand (right) tapping the SCGC-0.2-based sealed multilayer TENG;

FIG. 38B is a schematic diagram illustrating the working mechanism of the SCGC-0.2-based sealed multilayer TENG upon the tapping-releasing process;

FIG. 39A shows the V_{OC} of the SCGC-0.2-based sealed multilayer TENG when being tapped by and released from a finger or a hand;

FIG. 39B shows the Q_{SC} of the SCGC-0.2-based sealed multilayer TENG when being tapped by and released from a finger or a hand;

FIG. 39C shows the I_{SC} of the SCGC-0.2-based sealed multilayer TENG when being tapped by and released from a finger or a hand;

FIG. 40 shows the comparison of V_{OC} of finger tapping-releasing SCGC-0.2-based sealed multilayer TENG with the reported devices;

FIG. 41 shows the voltage against time upon hand tapping-releasing the SCGC-0.2-based sealed multilayer TENG for 5 min to charge a 10 F capacitor and powering a stopwatch;

FIG. 42A shows the photo of powering a stopwatch;

FIG. 42B shows the electric circuit of the device for charging a stopwatch; and

FIG. 42C shows the photos of powering a stopwatch for 5 s. The values in the left-hand corner of each photo denotes the sequence of the photos.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. For example, “about 1:1.67” may be meant 1:1.66, 1:1.65, 1:1.666, 1:1.665, 1:1.668, 1:1.671, 1:1.672 and the like; “about 1:1.25” may be meant 1:1.24, 1:1.245, 1:1.246, 1:1.248, 1.251, 1.252 and the like; “about 1:88” may be meant 1:87.6, 1:87.9, 1:88.1, 1:88.3 and the like. Some further examples have also been described throughout the present disclosure.

It is believed that water may act as a tribo-positive material and as an ionic migration medium between the tribolayer and the electrode, and therefore insufficient water content may cause hindrance to ion mobility, resulting in low ionic conductivity. On the other hand, it is also believed that excessive water content leads to charge dissipation. It is therefore believed that adjusting the water content may avoid charge dissipation and may be crucial to improving the electric output.

Without wishing to be bound by theory, the inventors have, through their own research, trials, and experiments, devised that by doping, in particular, co-doping a hygroscopic agent and a metal salt to a biomass-based material may improve both the tribopositivity and conductivity thereof. It is believed that the hygroscopic agent may facilitate the formation of hydrogen bond within the structure of the biomass-based material, and the cation of the metal salt may chelate the functional groups (e.g. acetate group, sulfonate group, etc.) of the biomass-based material leading to the formation of a cross-linked network. In addition, the anion of the metal salt may improve the electron-donating ability and the dielectric constant of the biomass-based material. In some embodiments, the biomass-based material of the present invention may have a stretchability of about 1008% elongation at break and a conductivity of about 2×10⁻¹ S m⁻¹.

In a first aspect of the present invention, there is provided a material, particularly a tribo-positive material, for triboelectric nanogenerator comprising a biomass-based material co-doped with a hygroscopic agent and a metal salt, wherein: the biomass-based material includes any one of a saccharide-based material; the hygroscopic agent includes any one of a polyol-based compound, a sulfone-based compound, a tetrahydropyran-based, or a isocyanate-based compound; and the metal salt includes any one of a monovalent metal salt, a divalent metal salt or a trivalent metal salt.

In some embodiments, the saccharide-based material may comprise sodium alginate, lignin, cellulose, starch, sodium lignosulfonate, sodium carboxymethylcellulose, Arabic gum, maltose, glucose, natural resin (such as polyurethane resin and acrylic resin), and chitin. Without wishing to be bound by theory, it is believed that these saccharide-based materials may have good solubility and that are favorable for forming chelate with the metal salt and hydrogen bond with the hygroscopic agent. In some particular embodiments, the biomass-based material may be selected from the group consisting of sodium alginate, sodium lignosulfonate, sodium carboxymethylcellulose and a combination thereof.

As mentioned herein, it is believed that the adjustment of water content of the biomass-based material is important for improving the electric output of the TENG. Without wishing to be bound by theory, it is believed that the hygroscopic agents as described herein, together with water molecules, may allow the rigid hydrogen bond between the polymer backbones or polymer chains to reform, and the cation of the metal salts as described herein may be arranged to form chelates with the functional groups of the biomass-based material, thereby forming a cross-linked network that may improve water-trapping ability of the biomass-based material. In addition, it is believed that the chelates may have a micro-net structure that may be beneficial for facilitating mobility. It is also believed that the anion of the metal salts and the presence of the trapped water molecules (as a result of the formation of the above cross-linked network) may improve the electron-donating ability and dielectric constant of the biomass-based material. Taken the above all together, it is therefore believed that by co-doping the hygroscopic agent and the metal salt as described herein may improve stretchability, ionic conductivity as well as tribopositivity, and the biomass-based material may be used as both a positive tribolayer and electrode simultaneously.

In some embodiments, the hygroscopic agent includes at least one of:

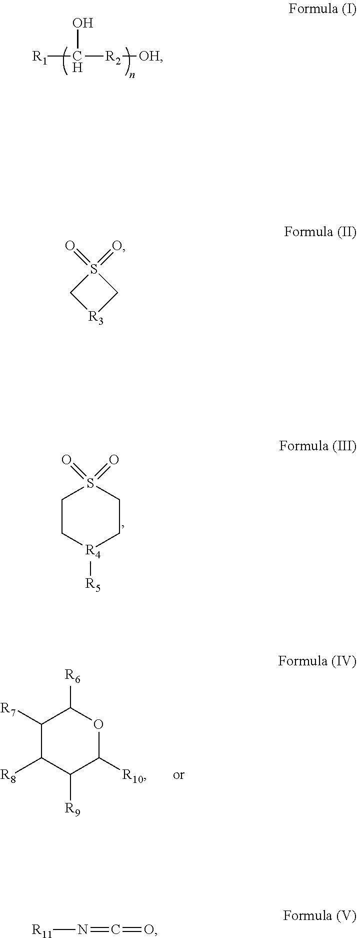

wherein:
n is positive integer such as 1-4;
R₁ and R₂ are independently selected from hydrogen, an alkyl group, hydroxyl group, hydroxyalkyl group, carbonyl group, alkylcarbonyl group, sulfhydryl group, or amino group;
R₃ is selected from an alkyl group, alkoxy group, hydroxyalkyl group, alkylmercapto group, alkylamino group, or alkylsulfone group, with 1-10 carbon atoms;
R₄ is a nitrogen or sulfur element;
R₅ is a hydroxyl group, sulfhydryl group or amino group;
R₆, R₇, R₈, R₉ and R₁₀ are independently selected from an alkyl group, hydroxyl group, hydroxyalkyl group, a sulfhydryl group or an amino group, with 1-10 carbon atoms; and
R₁₁ is selected from an alkyl group, hydroxyl group, hydroxyalkyl group, isocyanate, alkyl isocyanate, sulfhydryl group or amino group, with 1-10 carbon atoms.

The alkyl group may be linear or branched, and may be with 1-10 carbon atoms. Examples of C1-10 linear alkyl groups may include methyl, ethyl, propyl, butyl, pentyl, hexyl, heptyl, octyl, nonyl, and decyl. Examples of C1-10 branched alkyl groups may include isopropyl, n-butyl, isobutyl, sec-butyl, tert-butyl, n-pentyl (amyl), tert-pentyl, neopentyl, isopentyl (isoamyl), sec-pentyl, 3-pentyl, sec-isopentyl, active pentyl and the like.

The alkoxy group may be an alkyl group as described herein which is singularly bonded to oxygen. Examples may include methoxy, ethoxy, propoxy, butoxy, pentoxy, hexoxy, heptoxy, octoxy, nonoxy, decoxy, isopropoxy, n-butoxy, isobutoxy, sec-butoxy, tert-butoxy, n-pentoxy, tert-pentoxy, neopentoxy, isopentoxy, sec-pentoxy, 3-pentoxy, sec-isopentoxy and the like.

The hydroxyalkyl group may be an alkyl group as described herein which is singularly bonded to an oxygen that is covalently bonded to one hydrogen atom. Examples may include hydroxymethyl, 2-hydroxyethyl, 2-hydroxypropyl, 3-hydroxypropyl, 1-(hydroxymethyl)-2-methylpropyl, 2-hydroxybutyl, 3-hydroxybutyl, 4-hydroxybutyl, 2,3-dihydroxypropyl, 1-(hydroxymethyl)-2-hydroxyethyl, 2,3-dihydroxybutyl, 3,4-dihydroxybutyl, 2-(hydroxymethyl)-3-hydroxypropyl, and the like.

The alkylcarbonyl group may be a carbonyl group that is singularly bonded to an alkyl group as described herein (i.e. —(O═)C-alkyl). Examples may include methylcarbonyl, ethylcarbonyl, propylcarbonyl, isobutylcarbonyl, tert-pentylcarbonyl and the like.

The alkylmercapto may be an alkyl group as described herein which is singularly bonded to a sulfhydryl group. Examples may include methylmercapto, ethylmercapto, tert-butylmercapto, isopentylmercapto and the like.

The alkylamino group may include primary alkylamino group and secondary alkylamino group, with the alkyl group being described herein. Examples of primary alkylamino group may include methylamino, ethylamino and the like. Examples of secondary alkylamino group may include dimethylamino, N-methylbutylamino, N-methyl-tert-butylamino, N-methyl-N-propylamino, N-methyl-2-butylamino and the like.

The alkylsulfone group may have a general formula of alkyl-S(═O)₂-alkyl′-, with alkyl and alkyl′ being the alkyl groups as described herein. Examples of alkylsulfone may include ethyl propyl sulfone, methyl isopropyl sulfone, methyl butyl sulfone, methyl isobutyl sulfone, methyl 1,1-dimethylethyl sulfone, methyl pentyl sulfone, methyl 1,2-dimethylpropyl sulfone, methyl 2-methylbutyl sulfone, methyl 2,2-dimethylpropyl sulfone, ethyl propyl sulfone, ethyl isopropyl sulfone, ethyl butyl sulfone, ethyl isobutyl sulfone, ethyl pentyl sulfone, ethyl 1,2-dimethylpropyl sulfone, isopropyl propyl sulfone, isopropyl isopropyl sulfone, isopropyl butyl sulfone and the like.

The alkyl isocyanate may have a general formula of alkyl-N═C═O, with the alkyl being the alkyl group as described herein. Examples may include methylisocyanate, ethylisocyanate, propylisocyanate, isopropylisocyanate, tert-butylisocyanate and the like.

In some particular embodiments, the hygroscopic agent of Formula (I) may be selected from the group consisting of glycerol, ethylene glycol, butylene glycol, such as, in particular, 1,2-butanediol, glyoxylic acid monohydrate and a combination thereof.

In some particular embodiments, the hygroscopic agent of Formula (II) and Formula (III) may be selected from the group consisting of:

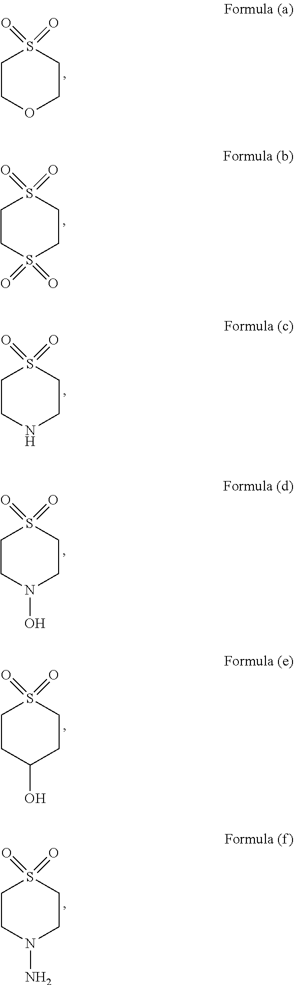 [SMILES: O=S1(=O)CCOCC1 ; O=S1(=O)CCS(=O)(=O)CC1 ; O=S1(=O)CCNCC1 ; O=S1(=O)CCN(O)CC1 ; O=S1(=O)CCC(O)CC1 ; NN1CCS(=O)(=O)CC1]

, and a combination thereof.

In some particular embodiments, the hygroscopic agent of Formula (IV) may be selected from the group consisting of:

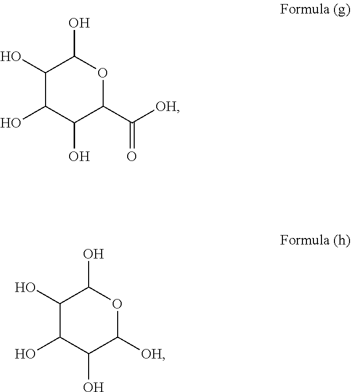 [SMILES: O=C(O)C1OC(O)C(O)C(O)C1O ; OC1OC(O)C(O)C(O)C1O]

and a combination thereof.

In some particular embodiments, the hygroscopic agent of Formula (V) is selected from the group consisting of:

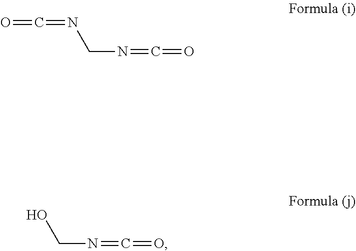 [SMILES: O=C=NCN=C=O ; O=C=NCO]

and a combination thereof.

In some embodiments, the biomass-based material may have a weight ratio of the hygroscopic agent to the biomass-based material from about 1:5 to about 2:1 such as about 1:5, about 1:2, about 1:1.67, about 1:1.25, about 1:1, about 1.2:1, about 1.5:1, about 2:1 and the like.

The metal salt may include halide, nitrate, sulfate, carbonate, sulfite, hydroxide, borate (such as tetrahydroxyborate, orthoborate, perborate, metaborate, diborate, triborate, tetraborate, tetrahydroxytetraborate, tetraborate(6-), pentaborate, octaborate and the like), oxalate, difluorooxalatoborate, bisoxalate borate, phosphate, fluorosulfonimide, alkylfluorosulfonimide, sulfonate, alginate, lignosulfonate or carboxymethyl cellulose of various monovalent, divalent or trivalent metals, such as lithium, calcium, iron(II), iron(III), copper(II), cobalt(II) or zinc(II).

In some embodiments, the metal salt may be selected from any one of zinc(II) bisoxalate borate, lithium bisoxalate borate, zinc(II) dimethylfluorosulfonimide, lithium dimethylfluorosulfonimide, calcium chloride, copper(II) chloride, zinc(II) chloride, cobalt(II) chloride, iron(III) chloride, iron(II) sulfate, copper(II) sulfate or zinc(II) sulfate.

The weight ratio of the metal salt to the biomass-based material may be from about 1:100 to about 1:25, such as about 1:100, about 1:88, about 1:71, about 1:67, about 1:63, about 1:50, about 1:44, about 1:29 and the like.

In some particular embodiments, the biomass-based material may be selected from the group consisting of sodium alginate, sodium lignosulfonate, sodium carboxymethylcellulose and a combination thereof; the hygroscopic agent is selected from the group consisting of glycerol, glyoxylic acid monohydrate, Formula (c), Formula (e), Formula (f), Formula (g), Formula (h), Formula (i), Formula (j) and a combination thereof; the metal salt is selected from the group consisting of zinc(II) chloride, copper(II) chloride and a combination thereof.

In some example embodiments, the biomass-based material may be sodium alginate or sodium lignosulfonate; the hygroscopic agent may be selected from the group consisting of glyoxylic acid monohydrate, Formula (c), Formula (e), Formula (f), Formula (g), Formula (h), Formula (i), Formula (j) and a combination thereof; the metal salt is zinc(II) chloride or copper(II) chloride. For example, in some particular example embodiments, the biomass-based material may be sodium alginate; the hygroscopic agent may be any one of or any two of glyoxylic acid monohydrate, Formula (c), Formula (e), Formula (f), Formula (g), Formula (h), Formula (i), or Formula (j); the metal salt may be either zinc(II) chloride or copper(II) chloride.

In some other example embodiments, the biomass-based material may be sodium carboxymethylcellulose; the hygroscopic agent may be glycerol; and the metal salt may be copper(II) chloride.

In a second aspect of the present invention, there is provided a triboelectric nanogenerator comprising: a first member including a tribo-positive layer of the material as described herein and a positive electrode; a second member including a tribo-negative layer and a negative electrode; the first and second members are spatially separated from one another thereby permits relative movement of the first member and the second member for generating a potential difference between them as a result of triboelectrification effect. In particular, when the tribo-positive layer and the tribo-negative layer come in contact, electrons may be transferred from the tribo-positive layer to the tribo-negative layer. Upon separation, positive charges are inducted on the negative electrode, and negative charges are inducted on the positive electrode, producing a current flow from the positive electrode to the negative electrode. As the tribo-positive and tribo-negative layers come closer, opposite charges are inducted on the electrodes, and thus current flows from the negative electrode to the positive electrode.

In some embodiments, the spatial separation between the first and the second members may be maintained by a separating member. For example, the separating member may be inserted between and may be attached to the terminals of the tribo-positive and tribo-negative layers. In other words, the tribo-positive layer and the tribo-negative layer may sandwich the separating member at their terminals, such as directly sandwich the separating member at their terminals.

In some embodiments, the separating member may be deformable. In particular, the separating member may include a deformable material such as any one of foam, rubber, spring and the like. In some optional embodiments, the separating member may be non-deformable as long as the first member and the second member are sufficiently flexible to enable the triboelectrification effect as described herein to occur.

The spatial separation may vary in accordance with practical needs. In some embodiments, the spatial separation between the first member and the second member is from about 3 mm (such as from 2.95 mm . . . 2.98 mm . . . 3 mm, 3.01 mm . . . 3.05 mm) to about 10 mm (such as from 9.95 mm . . . 9.98 mm . . . 10 mm, 10.01 mm . . . 10.05 mm).

It is believed that the tribo-positive material as described herein may be operably compatible with tribolayer of various tribo-negative materials. In some embodiments, the tribo-negative layer may include any one of polytetrafluoroethylene (PTFE), fluorinated ethylene propylene (FEP), silicon rubber (i.e. Ecoflex), polydimethylsiloxane (PDMS), polyvinyl chloride (PVC), or polyvinyl alcohol (PVA). In some particular embodiments, the tribo-negative layer may include any one of FEP or PDMS.

In some embodiments, the triboelectric nanogenerator may further comprise a first substrate and a second substrate to each of which the first member and the second member are attached. Preferably, the first and the second substrates may be substantially flexible so that the substrates may adopt the profiles of their respective member during the triboelectrification event as described herein. In other words, the substantial flexibility of the substrates may be beneficial to preventing delamination between the substrates and the corresponding members. In some example embodiments, the first substrate and the second substrate may include any one of polyethylene terephthalate or silicon rubber.

In some embodiments, the first substrate and the second substrate may be each in form of a layer and are independent from each other. In some embodiments, the first substrate and the second substrate may be integrated to form an encapsulation encapsulating the triboelectric nanogenerator.

In some embodiments, the second substrate may be configured to act as another tribo-negative layer thereby permits charge transfer to occur between the second substrate and a standalone tribo-positive material. In these embodiments, the standalone tribo-positive material may include a body part of a living subject such as a hand or finger of a living human. The body part may induce charge transfer from which to the second substrate upon contact as described in the later part of the present disclosure.

In some embodiments, the positive electrode and the negative electrode may have different materials. For example, the positive electrode may have the same material as the tribo-positive layer whereas the negative electrode may include a Ni/Ag conductive tape. In some particular embodiments, the positive electrode having the same material as the tribo-positive layer may be further integrated with the tribo-positive layer to form a single layer. In another example, the positive electrode may have the same material as the tribo-positive layer whereas the negative electrode may have the same material as the tribo-negative layer such as any one of the tribo-negative material as described herein. In some particular embodiments, the negative electrode may be integrated with the tribo-negative layer to form a single layer.

In some embodiments, the positive electrode and the negative electrode may have the same materials. For example, both the positive electrode and the negative electrode may include Ni/Ag conductive tape. In another example, both the positive electrode and the negative electrode may have the same material as the tribo-positive layer. In particular, the positive electrode may be integrated with the tribo-positive layer to form a single layer.

It is believed that the triboelectric nanogenerator as described herein may be suitable for various applications such as monitoring relative humidity (RH), harvesting biomechanical energy, etc. In an example embodiment where the triboelectric nanogenerator is used for harvesting biomechanical energy, such as harvesting the mechanical energy generated from the bending action of a finger, the triboelectric nanogenerator may be bendable away from a horizontal plane by about 30° (such as from 28°, 28.1° . . . 28.6° . . . 29.5° . . . 29.9°, 30°, 30.1° . . . 31.3° . . . 32° and the like) to about 90° (such as from 88°, 88.1° . . . 88.6° . . . 89.5° . . . 89.9°, 90°, 90.1° . . . 91.3° . . . 92° and the like).

Hereinafter, the present invention is described more specifically by way of examples, but the present invention is not limited thereto.

### EXAMPLES

### Materials and Methods

### Materials

Sodium carboxymethylcellulose (SC) (purity: 99.5%) was purchased from Alfa Aesar. Glycerol (purity: 99.5%), CuCl₂ 2H₂O (purity: 98%), glyoxylic acid monohydrate, sodium lignosulfonate and ZnCl₂ were purchased from Sigma Aldrich. FEP was purchased from Taizhou Chenguang Plastic Industry Co. Ltd. Ecoflex 0050, and PDMS were purchased from Smooth-On Incorporated and Dow Corning, respectively, polyethylene terephthalate (PET) and Nylon 66 were from Shanghai Huadong Insulation Filter Co., Ltd. and Dongguan Yixuan Plastic Co., Ltd. The hygroscopic agents of Formula (c), Formula (e), Formula (f), Formula (g), Formula (h), Formula (i), and Formula (j) were prepared by reported method.

### Characterization

The surface topography of obtained films was characterized by scanning electron microscope (SEM, Carl Zeiss LEO 1530VP). Element distribution maps were characterized by energy dispersive X-ray spectroscopy (EDS, Carl Zeiss LEO 1530VP). Functional groups characterization was tested by Fourier-transform infrared spectroscopy (FTIR, Shimadzu IRAffinity-1). Transmittance curves were obtained by Ultraviolet-visible spectroscopy (UV-VIS, Shimadzu UV-2600). The patterns of surface potential were obtained by kelvin probe force microscopy (KPFM, Bruker Dimension Icon) at RH of 60% and 25° C. Tensile strength-strain curves were recorded by a mechanical tester (Instron, 5566) with sample dimension of 5×1 cm² at an elongation speed of 50 mm min⁻¹ to 100 mm min⁻¹ at RH of 60% and 25° C. Electrochemical Impedance Spectroscopy (EIS) curves were recorded by an electrochemical workstation (CHI 760E). Signals of voltage, quantity of charge and current were obtained by an electrometer Keithley 6514 oscilloscope.

### Calculation of Dielectric Constant

The dielectric constant was tested by AC impedance method.

$${ε}^{′} = \frac{{Z}^{″}}{ω {C}_{0} ( {Z}^{′2} + {Z}^{″2} )} \qquad ( A )$$

$${C}_{0} = \frac{{e}_{0} A}{l} \qquad ( B )$$

where, ε′ is dielectric constant. ω is the angular frequency, and ω=2πf. C₀ is vacuum capacitance. e₀ is the dielectric constant of vacuum space, 8.854×10⁻¹² F/m. A and l are the area and thickness of the sample, respectively.

### Example 1

### Preparation of Biomass-Based Triboelectric Material 1 (Sample 1) and the Triboelectric Nanogenerator Thereof (TENG 1)

0.5 g sodium alginate, 0.5 g glyoxylic acid monohydrate and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 1.

PDMS is used as a negative tribo-layer and Sample 1 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 1) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 2

### Preparation of Biomass-Based Triboelectric Material 2 (Sample 2) and the Triboelectric Nanogenerator Thereof (TENG 2)

The preparation of Sample 2 is the same as Sample 1 expect that 0.4 g of glyoxylic acid monohydrate was used.

The preparation of TENG2 is the same as TENG 1 expect that Sample 2 was used.

### Example 3

### Preparation of Biomass-Based Triboelectric Material 3 (Sample 3) and the Triboelectric Nanogenerator Thereof (TENG 3)

The preparation of Sample 3 is the same as Sample 1 expect that 0.6 g of glyoxylic acid monohydrate was used.

The preparation of TENG 4 is the same as TENG 1 expect that Sample 3 was used.

### Example 4

### Preparation of Biomass-Based Triboelectric Material 4 (Sample 4) and the Triboelectric Nanogenerator Thereof (TENG 4)

The preparation of Sample 4 is the same as Sample 1 expect that 0.1 g of glyoxylic acid monohydrate was used.

The preparation of TENG 4 is the same as TENG 1 expect that Sample 4 was used.

### Example 5

### Preparation of Biomass-Based Triboelectric Material 5 (Sample 5) and the Triboelectric Nanogenerator Thereof (TENG 5)

The preparation of Sample 5 is the same as Sample 1 expect that 1 g of glyoxylic acid monohydrate was used.

The preparation of TENG 5 is the same as TENG 1 expect that Sample 5 was used.

### Example 6

### Preparation of Biomass-Based Triboelectric Material 6 (Sample 6) and the Triboelectric Nanogenerator Thereof (TENG 6)

0.5 g sodium alginate, 0.5 g hygroscopic agent of Formula (c) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 6.

PDMS is used as a negative tribo-layer and Sample 6 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 6) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 7

### Preparation of Biomass-Based Triboelectric Material 7 (Sample 7) and the Triboelectric Nanogenerator Thereof (TENG 7)

The preparation of Sample 7 is the same as Sample 6 expect that 0.4 g hygroscopic agent of Formula (c) was used.

The preparation of TENG 7 is the same as TENG 6 expect that Sample 7 was used.

### Example 8

### Preparation of Biomass-Based Triboelectric Material 8 (Sample 8) and the Triboelectric Nanogenerator Thereof (TENG 8)

The preparation of Sample 8 is the same as Sample 6 expect that 0.6 g hygroscopic agent of Formula (c) was used.

The preparation of TENG 8 is the same as TENG 6 expect that Sample 8 was used.

### Example 9

### Preparation of Biomass-Based Triboelectric Material 9 (Sample 9) and the Triboelectric Nanogenerator Thereof (TENG 9)

The preparation of Sample 9 is the same as Sample 6 expect that 0.1 g hygroscopic agent of Formula (c) was used.

The preparation of TENG 9 is the same as TENG 6 expect that Sample 9 was used.

### Example 10

### Preparation of Biomass-Based Triboelectric Material 10 (Sample 10) and the Triboelectric Nanogenerator Thereof (TENG 10)

The preparation of Sample 10 is the same as Sample 6 expect that 1 g hygroscopic agent of Formula (c) was used.

The preparation of TENG 10 is the same as TENG 6 expect that Sample 10 was used.

### Example 11

### Preparation of Biomass-Based Triboelectric Material 11 (Sample 11) and the Triboelectric Nanogenerator Thereof (TENG 11)

0.5 g sodium alginate, 0.5 g hygroscopic agent of Formula (f) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 11.

PDMS is used as a negative tribo-layer and Sample 6 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 11) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 12

### Preparation of Biomass-Based Triboelectric Material 12 (Sample 12) and the Triboelectric Nanogenerator Thereof (TENG 12)

The preparation of Sample 12 is the same as Sample 11 expect that 0.4 g hygroscopic agent of Formula (f) was used.

The preparation of TENG 12 is the same as TENG 11 expect that Sample 12 was used.

### Example 13

### Preparation of Biomass-Based Triboelectric Material 13 (Sample 13) and the Triboelectric Nanogenerator Thereof (TENG 13)

The preparation of Sample 13 is the same as Sample 11 expect that 0.6 g hygroscopic agent of Formula (f) was used.

The preparation of TENG 13 is the same as TENG 11 expect that Sample 13 was used.

### Example 14

### Preparation of Biomass-Based Triboelectric Material 14 (Sample 14) and the Triboelectric Nanogenerator Thereof (TENG 14)

The preparation of Sample 14 is the same as Sample 11 expect that 0.1 g hygroscopic agent of Formula (f) was used.

The preparation of TENG 14 is the same as TENG 11 expect that Sample 14 was used.

### Example 15

### Preparation of Biomass-Based Triboelectric Material 15 (Sample 15) and the Triboelectric Nanogenerator Thereof (TENG 15)

The preparation of Sample 15 is the same as Sample 11 expect that 1 g hygroscopic agent of Formula (f) was used.

The preparation of TENG 15 is the same as TENG 11 expect that Sample 13 was used.

### Example 16

### Preparation of Biomass-Based Triboelectric Material 16 (Sample 16) and the Triboelectric Nanogenerator Thereof (TENG 16)

0.5 g sodium alginate, 0.5 g hygroscopic agent of Formula (g) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 16.

PDMS is used as a negative tribo-layer and Sample 16 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 16) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 17

### Preparation of Biomass-Based Triboelectric Material 17 (Sample 17) and the Triboelectric Nanogenerator Thereof (TENG 17)

The preparation of Sample 17 is the same as Sample 16 expect that 0.1 g hygroscopic agent of Formula (g) was used.

The preparation of TENG 17 is the same as TENG 16 expect that Sample 17 was used.

### Example 18

### Preparation of Biomass-Based Triboelectric Material 18 (Sample 18) and the Triboelectric Nanogenerator Thereof (TENG 18)

The preparation of Sample 18 is the same as Sample 16 expect that 1 g hygroscopic agent of Formula (g) was used.

The preparation of TENG 18 is the same as TENG 16 expect that Sample 18 was used.

### Example 19

### Preparation of Biomass-Based Triboelectric Material 19 (Sample 19) and the Triboelectric Nanogenerator Thereof (TENG 19)

0.5 g sodium alginate, 0.5 g hygroscopic agent of Formula (i) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 19.

PDMS is used as a negative tribo-layer and Sample 19 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 19) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 20

### Preparation of Biomass-Based Triboelectric Material 20 (Sample 20) and the Triboelectric Nanogenerator Thereof (TENG 20)

The preparation of Sample 20 is the same as Sample 19 expect that 0.4 g hygroscopic agent of Formula (i) was used.

The preparation of TENG 20 is the same as TENG 16 expect that Sample 20 was used.

### Example 21

### Preparation of Biomass-Based Triboelectric Material 21 (Sample 21) and the Triboelectric Nanogenerator Thereof (TENG 21)

The preparation of Sample 21 is the same as Sample 19 expect that 0.6 g hygroscopic agent of Formula (i) was used.

The preparation of TENG 21 is the same as TENG 19 expect that Sample 21 was used.

### Example 22

### Preparation of Biomass-Based Triboelectric Material 22 (Sample 22) and the Triboelectric Nanogenerator Thereof (TENG 22)

The preparation of Sample 22 is the same as Sample 19 expect that 0.1 g hygroscopic agent of Formula (i) was used.

The preparation of TENG 22 is the same as TENG 19 expect that Sample 22 was used.

### Example 23

### Preparation of Biomass-Based Triboelectric Material 23 (Sample 23) and the Triboelectric Nanogenerator Thereof (TENG 23)

The preparation of Sample 23 is the same as Sample 19 expect that 1 g hygroscopic agent of Formula (i) was used.

The preparation of TENG 23 is the same as TENG 19 expect that Sample 23 was used.

### Example 24

### Preparation of Biomass-Based Triboelectric Material 24 (Sample 24) and the Triboelectric Nanogenerator Thereof (TENG 24)

0.5 g sodium alginate, 0.3 g glyoxylic acid monohydrate, 0.2 g hygroscopic agent of Formula (c) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 24.

PDMS is used as a negative tribo-layer and Sample 24 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 24) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 25

### Preparation of Biomass-Based Triboelectric Material 25 (Sample 25) and the Triboelectric Nanogenerator Thereof (TENG 25)

0.5 g sodium alginate, 0.3 g glyoxylic acid monohydrate, 0.2 g hygroscopic agent of Formula (f) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 25.

PDMS is used as a negative tribo-layer and Sample 25 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 25) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 26

### Preparation of Biomass-Based Triboelectric Material 26 (Sample 26) and the Triboelectric Nanogenerator Thereof (TENG 26)

0.5 g sodium alginate, 0.3 g glyoxylic acid monohydrate, 0.2 g hygroscopic agent of Formula (g) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 26.

PDMS is used as a negative tribo-layer and Sample 26 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 26) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 27

### Preparation of Biomass-Based Triboelectric Material 27 (Sample 27) and the Triboelectric Nanogenerator Thereof (TENG 27)

0.5 g sodium alginate, 0.3 g glyoxylic acid monohydrate, 0.2 g hygroscopic agent of Formula (i) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 27.

PDMS is used as a negative tribo-layer and Sample 27 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 27) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 28

### Preparation of Biomass-Based Triboelectric Material 28 (Sample 28) and the Triboelectric Nanogenerator Thereof (TENG 28)

0.5 g sodium alginate, 0.25 g glyoxylic acid monohydrate, 0.15 g hygroscopic agent of Formula (c) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 28.

PDMS is used as a negative tribo-layer and Sample 28 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 28) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 29

### Preparation of Biomass-Based Triboelectric Material 29 (Sample 29) and the Triboelectric Nanogenerator Thereof (TENG 29)

The preparation of Sample 29 is the same as Sample 28 expect that 0.35 g glyoxylic acid monohydrate and 0.25 g hygroscopic agent of Formula (c) were used.

The preparation of TENG 29 is the same as TENG 28 expect that Sample 29 was used.

### Example 30

### Preparation of Biomass-Based Triboelectric Material 30 (Sample 30) and the Triboelectric Nanogenerator Thereof (TENG 30)

0.5 g sodium alginate, 0.3 g glyoxylic acid monohydrate, 0.2 g hygroscopic agent of Formula (c) and 0.007 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 30.

PDMS is used as a negative tribo-layer and Sample 30 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 30) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 31

### Preparation of Biomass-Based Triboelectric Material 31 (Sample 31) and the Triboelectric Nanogenerator Thereof (TENG 31)

The preparation of Sample 31 is the same as Sample 30 expect that 0.008 g of ZnCl₂ was used.

The preparation of TENG 31 is the same as TENG 30 expect that Sample 31 was used.

### Example 32

### Preparation of Biomass-Based Triboelectric Material 32 (Sample 32) and the Triboelectric Nanogenerator Thereof (TENG 32)

The preparation of Sample 32 is the same as Sample 30 expect that 0.005 g of ZnCl₂ was used.

The preparation of TENG 32 is the same as TENG 30 expect that Sample 32 was used.

### Example 33

### Preparation of Biomass-Based Triboelectric Material 33 (Sample 33) and the Triboelectric Nanogenerator Thereof (TENG 33)

The preparation of Sample 33 is the same as Sample 30 expect that 0.01 g of ZnCl₂ was used.

The preparation of TENG 33 is the same as TENG 30 expect that Sample 33 was used.

### Example 34

### Preparation of Biomass-Based Triboelectric Material 34 (Sample 34) and the Triboelectric Nanogenerator Thereof (TENG 34)

0.5 g sodium lignosulfonate, 0.3 g glyoxylic acid monohydrate, 0.2 g hygroscopic agent of Formula (c) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 34.

PDMS is used as a negative tribo-layer and Sample 34 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 34) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 35

### Preparation of Biomass-Based Triboelectric Material 35 (Sample 35) and the Triboelectric Nanogenerator Thereof (TENG 35)

The preparation of Sample 35 is the same as Sample 34 expect that 0.075 g of CuCl₂ was used.

The preparation of TENG 35 is the same as TENG 30 expect that Sample 35 was used.

### Example 36

### Preparation of Biomass-Based Triboelectric Material 36 (Sample 36) and the Triboelectric Nanogenerator Thereof (TENG 36)

0.5 g sodium lignosulfonate, 0.3 g hygroscopic agent of Formula (c), 0.2 g hygroscopic agent of Formula (e) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 36.

PDMS is used as a negative tribo-layer and Sample 36 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 36) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 37

### Preparation of Biomass-Based Triboelectric Material 37 (Sample 37) and the Triboelectric Nanogenerator Thereof (TENG 37)

0.5 g sodium lignosulfonate, 0.3 g hygroscopic agent of Formula (c), 0.2 g hygroscopic agent of Formula (h) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 37.

PDMS is used as a negative tribo-layer and Sample 37 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 37) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 38

### Preparation of Biomass-Based Triboelectric Material 38 (Sample 38) and the Triboelectric Nanogenerator Thereof (TENG 38)

0.5 g sodium lignosulfonate, 0.3 g hygroscopic agent of Formula (c), 0.2 g hygroscopic agent of Formula (j) and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Sample 38.

PDMS is used as a negative tribo-layer and Sample 38 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Sample 38) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 39

### Preparation of Biomass-Based Triboelectric Material 39 (Comparative Sample 1) and the Triboelectric Nanogenerator Thereof (Comparative TENG 1)

0.5 g sodium alginate, 1.5 g glyoxylic acid monohydrate and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Comparative Sample 1.

PDMS is used as a negative tribo-layer and Comparative Sample 1 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Comparative Sample 1) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 40

### Preparation of Biomass-Based Triboelectric Material 40 (Comparative Sample 2) and the Triboelectric Nanogenerator Thereof (Comparative TENG 2)

The preparation of Comparative Sample 2 is the same as Sample 39 expect that 0.05 g of glyoxylic acid monohydrate was used.

The preparation of Comparative TENG 2 is the same as Comparative TENG 1 expect that Comparative Sample 2 was used.

### Example 41

### Preparation of Biomass-Based Triboelectric Material 41 (Comparative Sample 3) and the Triboelectric Nanogenerator Thereof (Comparative TENG 3)

0.5 g sodium alginate and 0.0075 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Comparative Sample 3.

PDMS is used as a negative tribo-layer and Comparative Sample 3 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Comparative Sample 3) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 42

### Preparation of Biomass-Based Triboelectric Material 42 (Comparative Sample 4) and the Triboelectric Nanogenerator Thereof (Comparative TENG 4)

0.5 g sodium alginate, 0.3 g glyocylic acid monohydrate, 0.2 g hygroscopic agent of Formula (c) and 0.004 g ZnCl₂ were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Comparative Sample 4.

PDMS is used as a negative tribo-layer and Comparative Sample 4 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Comparative Sample 4) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 43

### Preparation of Biomass-Based Triboelectric Material 43 (Comparative Sample 5) and the Triboelectric Nanogenerator Thereof (Comparative TENG 5)

The preparation of Comparative Sample 5 is the same as Comparative Sample 4 expect that 0.02 g of ZnCl₂ was used.

The preparation of Comparative TENG 5 is the same as Comparative TENG 4 expect that Comparative Sample 5 was used.

### Example 44

### Preparation of Biomass-Based Triboelectric Material 44 (Comparative Sample 6) and the Triboelectric Nanogenerator Thereof (Comparative TENG 6)

0.5 g sodium alginate, 0.3 g glyocylic acid monohydrate and 0.2 g hygroscopic agent of Formula (c) were added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Comparative Sample 6.

PDMS is used as a negative tribo-layer and Comparative Sample 6 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Comparative Sample 6) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 45

### Preparation of Biomass-Based Triboelectric Material 45 (Comparative Sample 7) and the Triboelectric Nanogenerator Thereof (Comparative TENG 7)

0.5 g sodium alginate was added into 20 ml water and stirred for 2 hours. Then, the mixture is poured into a mould (dimension: length: 10 cm, width: 5 cm) and dried at 25° C. for 48 hours to form a hydrogel film. This hydrogel is labelled as Comparative Sample 7.

PDMS is used as a negative tribo-layer and Comparative Sample 7 is used as a conductive positive tribo-layer. Specifically, 10 g PDMS and 1 g curing agent (Brand: DOWSIL 184) were mixed together and poured to a mould (dimension: length: 10 cm, width: 5 cm). Then the mould was transferred to an oven for curing at 80° C. for 6 hours. After that, the negative tribo-layer was formed. Next, the negative tribo-layer (PDMS) and the positive part (Comparative Sample 7) each were cut to 5 cm×1 cm. Then, two pieces of foam (thickness: 3 cm) was inserted between the terminals of the tribolayers so as to separate the positive part and negative part. The triboelectric nanogenerator may be taped on thumb to harvest bending-releasing energy.

### Example 46

### Preparation of SC, SCG Films and SCGC Films

The fabrication process is at RH of 60%. 5 g of SC was added into distilled water and stirred for 2 h at 25° C. to get 10 g L⁻¹ homogeneous SC solution. SC film was prepared by pouring 50 ml SC solution into a cultural dish (diameter: 9 cm) and placing the dish on the lab table for 5 days. SCGC films were fabricated by adding 0.25 g, 0.50 g, and 0.75 g of glycerol into 50 ml of SC solution (10 g L⁻¹), stirring for 2 h at 60° C. and drying at 25° C. for 5 days, respectively, which were labelled as SCG-0.25, SCG-0.50 and SCG-0.75.

For the preparation of SCGC films, firstly, 1.50 g of glycerol was added to 150 ml of SC solution (10 g L⁻¹) and stirred for 2 h at 60° C. After homogeneous mixing, this solution was equally divided into group A, group B, and group C. Then, 0.1 ml, 0.2 ml, and 0.3 ml of CuCl₂ solution (1 M) were dissolved in the three groups, and stirred for 2 h at 60° C., respectively. After drying at 25° C. for 5 days, three films were formed and labelled as SCGC-0.1, SCGC-0.2 and SCGC-0.3.

### Example 47

### Preparation of Triboelectric Nanogenerator of SC, SCG Films and SCGC Films Fabrication of Two-Electrode TENG

The fabrication process is at RH of 60% and 25° C. The obtained films (average thickness: 0.4 mm) and FEP (thickness: 0.1 mm) with a dimension of 2×2 cm² were selected as tribo-positive and tribo-negative layers, respectively. Conductive Ni/Ag tape was employed as the electrode and PET (thickness: 0.25 mm) with the dimension of 3×3 cm² was used as the substrate. The tribo-positive layer is separated from the tribo-negative layer by two pieces of foams.

### Fabrication of One-Electrode TENG

The fabrication process is at RH of 60% and 25° C. SCGC-0.2 was used as the tribo-positive layer and electrode simultaneously, while FEP was employed as the tribo-negative layer. Their dimensions were 1×5 cm². Two pieces of foam with a thickness of 3 mm were inserted between the terminals of the tribolayers. Optionally, the device may then be taped on a glove.

### Fabrication of Multilayer TENG

The fabrication process is at RH of 60% and 25° C. A SCGC-0.2 with the dimension of 1×5 cm² was employed as tribo-positive layer and electrode, while the other SCGC-0.2 was employed as an electrode taped on FEP film (dimension: 1×5 cm²). The gap distance between SCGC-0.2 and FEP was 3 mm. The tribolayers and electrodes were sealed by Ecoflex (i.e. silicon rubber). The tribo-positive layer is separated from the tribo-negative layer by two pieces of foams.

### Example 48

### Characterization of the Biomass-Based Triboelectric Materials 1-45 and the TENG Thereof

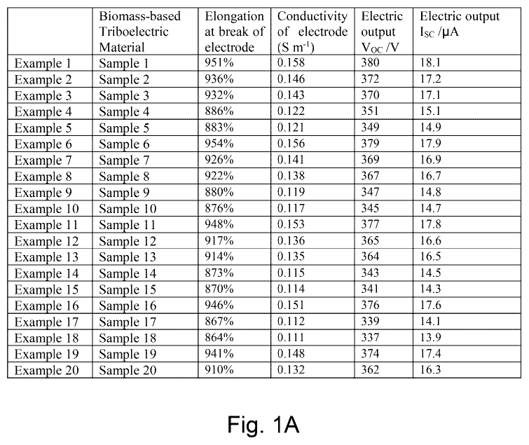

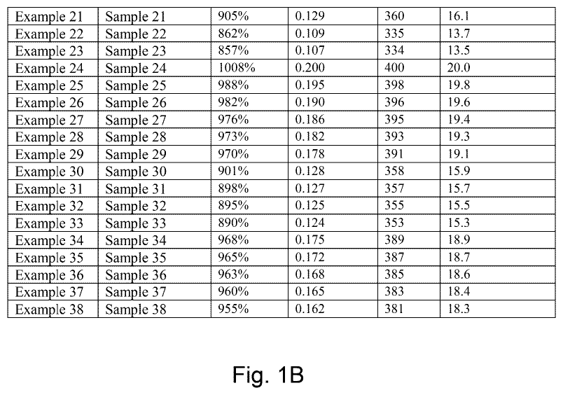

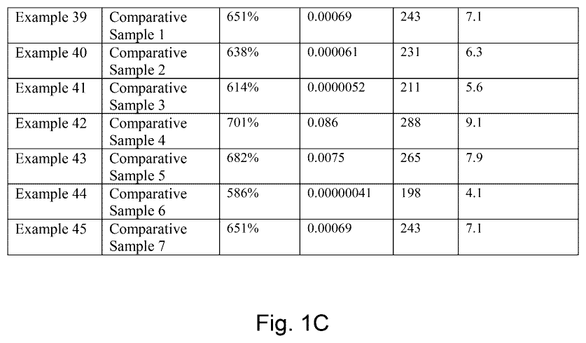

With reference to FIGS. 1A-1C, comparing Biomass-based Triboelectric Materials 1, 2-5 (i.e., Samples 1, 2-5), Comparative Samples 1-3 and Comparative Sample 7, the Biomass-based Triboelectric Material 1 shows the best performance of elongation at break (stretchability), conductivity and electric output. Compared to Biomass-based Triboelectric Materials 7-10, Biomass-based Triboelectric Material 6 shows the best performance of elongation at break, conductivity and electric output. Compared to Biomass-based Triboelectric Materials 12-15, Biomass-based Triboelectric Material 11 shows the best performance of elongation at break, conductivity and electric output. Compared to Biomass-based Triboelectric Materials 17-18, Biomass-based Triboelectric Material 16 shows the best performance of elongation at break, conductivity and electric output. Compared to Biomass-based Triboelectric Materials 20-23, Biomass-based Triboelectric Materials 19 shows the best performance of elongation at break, conductivity and electric output. Compared to Biomass-based Triboelectric Materials 28-29, Biomass-based Triboelectric Materials 24 shows the best performance of elongation at break, conductivity and electric output. Based on the above, it is believed that W_{biomass}:W_{hygroscopic agent}=1:1 is the optimal ratio, where W is weight.

Further referring to FIGS. 1A-1C, compared to Biomass-based Triboelectric Materials 2-5, Biomass-based Triboelectric Materials 25-27, and Biomass-based Triboelectric Materials 36-38, Biomass-based Triboelectric Material 24 shows the best performance of elongation at break, conductivity and electric output. These data indicate hygroscopic agent which includes glyoxylic acid monohydrate and Formula (c) is the optimal. In other words, it appears that two-hygroscopic-agent system is better than one-hygroscopic-agent system. It is believed that more crosslinks may be formed between two chemicals, and different sized molecules may facilitate breaking the rigid bonds of biomass, thereby facilitate the fixation of water molecules, and therefore improving mechanical properties, electrical conductivity and electrical output.

When compared to Biomass-based Triboelectric Materials 30-33 and Comparative Samples 4-7, Biomass-based Triboelectric Material 29 shows the best performance of elongation at break, conductivity and electric output (FIGS. 1A-1C). These data suggest that W_{biomass}:Wₛₐₗₜ=1:0.015 (or Wₛₐₗₜ:W_{biomass}=1:66.7) is the optimal ratio.

When compared to Biomass-based Triboelectric Material 34, Biomass-based Triboelectric Material 24 shows the best performance of elongation at break, conductivity and electric output (FIGS. 1A-1C). These data suggest that sodium alginate may be better than sodium lignosulfonate when couple with PDMS as the tribo-negative layer.

Comparing to Biomass-based Triboelectric Material 35, Biomass-based Triboelectric Material 24 shows the best performance of elongation at break, conductivity and electric output. It is therefore believed that ZnCl₂ may be better than CuCl₂ when a two-hygroscopic agent system is used.

Furthermore, the Biomass-based Triboelectric Materials 1-38 show a stratchability-elongate at break of electrode of about 857% to about 1008%. The conductivity of the electrodes is between about 1×10⁻¹ to 2×10⁻¹ (S m⁻¹). Also, the triboelectric nanogenerators with positive electrodes formed from the Biomass-based Triboelectric Materials 1-38 show an electric output V_{oc} of between about 334 V to about 400 V and short circuit current I_{SC} of about 13.5 μA to about 20 μA.

### Example 49

### Characterization of SC, SCG and SCGC Films

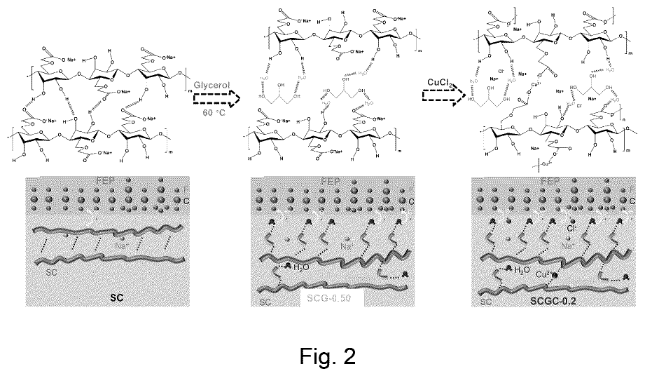

The water-trapped biomass with enhanced stretchability and conductivity was fabricated using glycerol and CuCl₂ as the plasticizer and the ionic cross-linker and they are mixed into an SC solution at 60° C. (FIG. 2). The films with weight ratio of SC to glycerol being 1:0.5, 1:1 and 1:1.5 are termed as SCG-0.25, SCG-0.50 and SCG-0.75, respectively. In addition, the films doped with 0.1, 0.2 and 0.3 mM CuCl₂ are termed SCGC-0.1, SCGC-0.2 and SCGC-0.3, respectively.

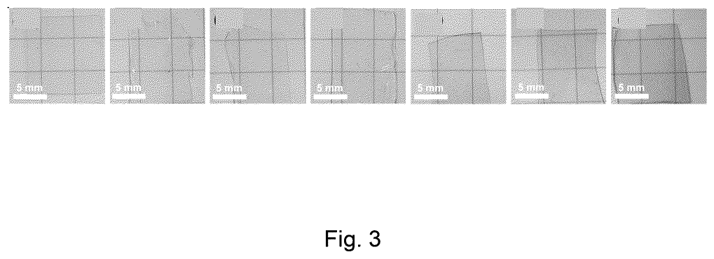

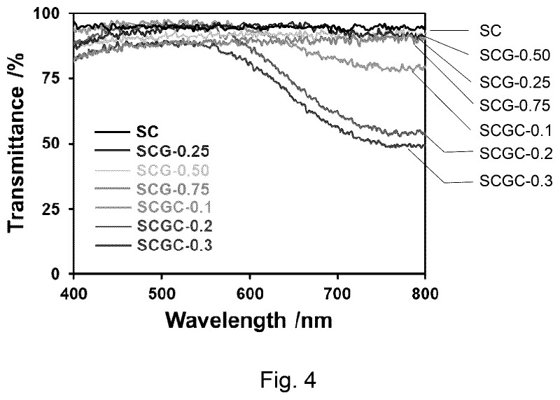

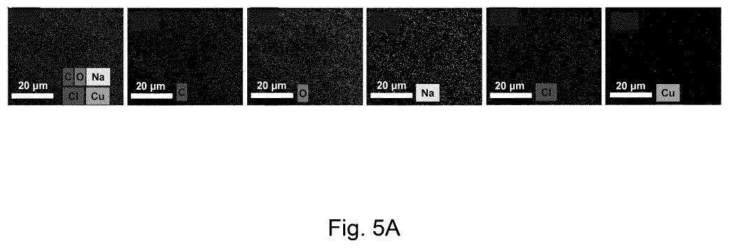

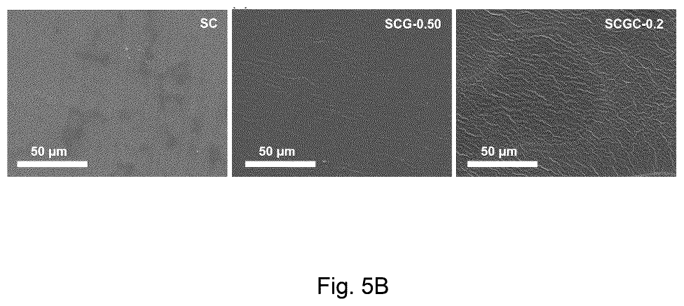

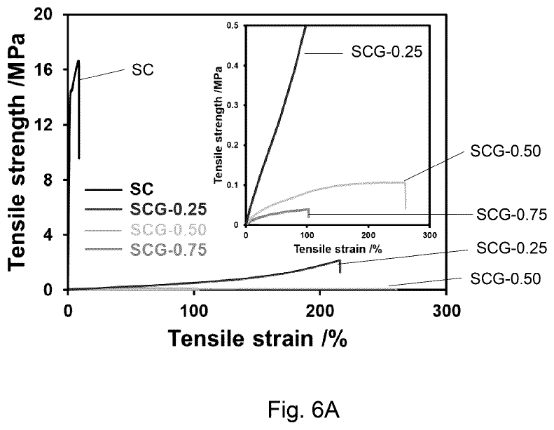

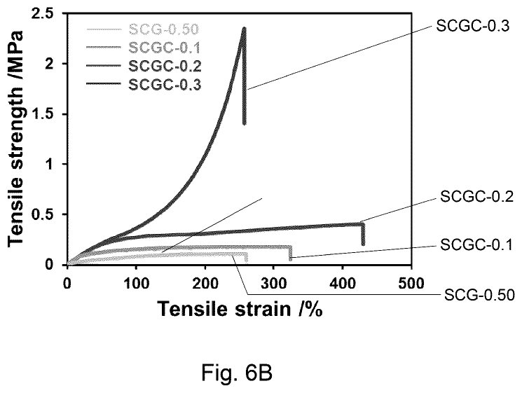

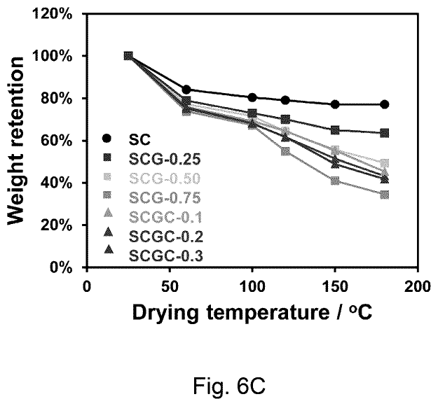

As shown in FIG. 3, SC and SCG films are colorless, but become transparent light blue after the introduction of Cu²⁺. The film transmittance in the region 400 to 600 nm is above 80%, but drops to 50%-75% for SCGC films in the region 600 to 800 nm (FIG. 4). It is believed that glycerol has three hydroxyl groups per molecule and thus can easily absorb water from the atmosphere. The introduction of glycerol and water allows the rigid hydrogen bonds between two adjacent SC chains to break, and new hydrogen bonds between glycerol, water, and SC to form (FIG. 2). Compared with SC, glycerol and water are much smaller, and thus act as lubricants, improving the stretchability of the film. Furthermore, CuCl₂ is found to distribute homogeneously in the SCGC-0.2 film (FIGS. 5A and 5B). Due to the stronger electrostatic force between Cu²⁺ and the carboxyl group COO⁻, Cu²⁺ displaces Na⁺ and participates in chelation between adjacent SC chains. Na⁺ has higher mobility and thus is able to move freely in the film with less hindrance when electric field is exerted. As shown in FIGS. 6A-6C, compared with SC with elongation at break of 9%, SCG-0.50 reaches 260%. Further, the film doped with 0.2 mM CuCl₂ reveals a 47.8-fold increase in elongation at break (430%) with a tensile strength of 0.4 MPa.

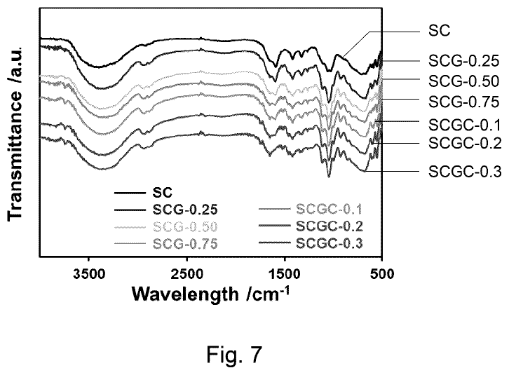

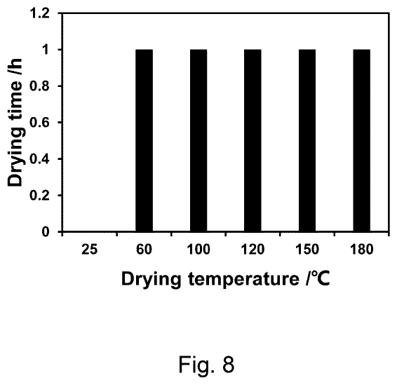

The FTIR curves (FIG. 7) show a peak at 3400 cm⁻¹, indicating that these samples contain absorbed water. Weight retention is investigated by placing the samples in an oven, setting the temperature to 60, 100, 120, 150 and 180° C. in proper order and keeping it for 1 h in each temperature. As shown in FIGS. 6C and 8, an increase in glycerol content decreases weight retention after drying. After drying at 100° C. for 1 h, the weight retention of SC, SCG-0.25, SCG-0.50, and SCG-0.75 are 80.4%, 72.9%, 71.43% and 67.23%, respectively. As SC degrades at 240° C., the weight loss under 100° C. is believed to be caused by water evaporation. The weights of hydrogel films do not show obvious decrease at 100° C., indicating water retention in the films. Therefore, it is believed that Cl⁻ and trapped water are retained in SCGC-0.2 at the same time. Since Cl⁻ and water have higher ability of donating electrons, compared to SC and SCG-0.50, more electrons transfer from SCGC-0.2 to FEP (a tribo-negative material) upon contact (FIG. 2).

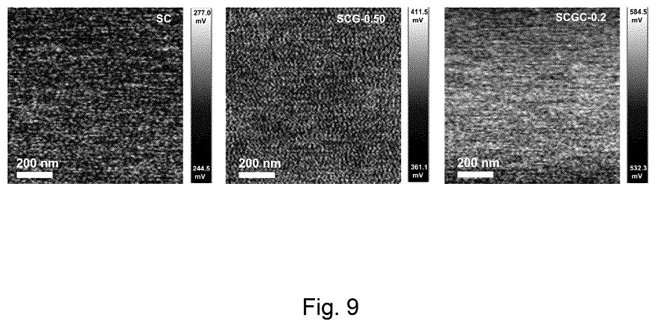

KPFM was used to study the surface potentials of SC, SCG-0.50 and SCGC-0.2. As shown in FIG. 9, compared with a surface potential of 260 mV (SC) and 386 mV (SCG-0.50), the surface potential of SCGC-0.2 is higher (558 mV), indicating a larger transferrable number of electrons from the positive tribolayer (tribo-positive layer).

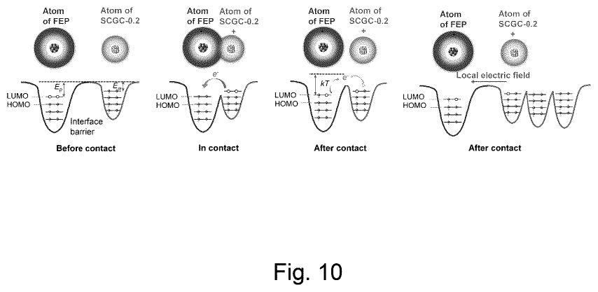

The charge transfer mechanism is illustrated as shown in FIG. 10. The oxygen atoms of the water of SCGC-0.2 are regarded as a potential well, and the surface fluorine atoms of FEP as electron acceptors. E_{P} and E_{W} represent the potential energy required for the electron to transfer from the LUMO of FEP and the oxygen atoms in SCGC-0.2. When SCGC-0.2 comes into contact with FEP, electrons transfer from SCGC-0.2 to the LUMO of FEP. Upon separation, if the electron energy fluctuation (kT) is higher than the potential barrier (Ep) of FEP, some electrons transfer out of the potential well. Due to polarization, water loses electrons upon contact with FEP causing polarization of surrounding water molecules.

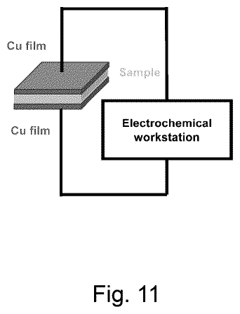

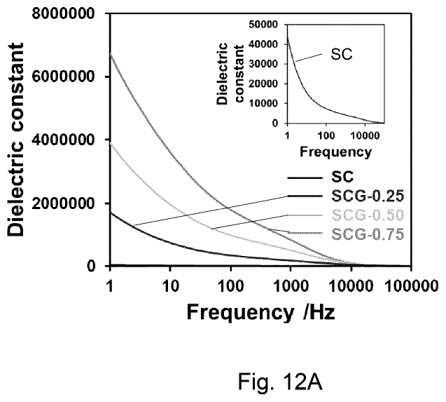

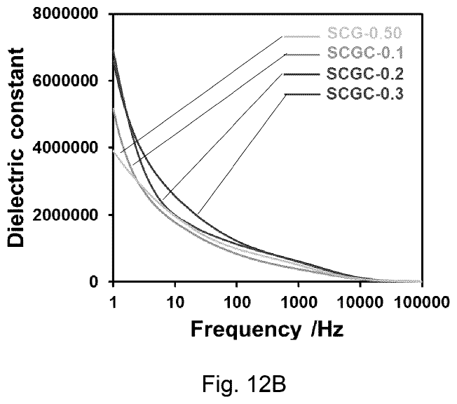

Apart from intrinsic tribopositivity, it is believed that these films may have different dielectric constants as a result of their different content of glycerol and CuCl₂. To confirm as such, the films were cut to 1×1 cm² and inserted between two Cu films linked to an electrochemical workstation (FIG. 11). At higher glycerol content, more water molecules are absorbed leading to increased ion mobility, and thus a double layer is formed at the interface between the hydrogel film and electrode. The dielectric constant at low-frequency is higher than that at high frequency as the increase of the charge carriers' concentration at the interface lead to electrode polarization. As shown in FIGS. 12A and 12B, the dielectric constant of SCG-0.75 is higher than SC, SCG-0.25 and SCG-0.50, which indicates increasing dielectric constant with increasing glycerol content. Furthermore, based on the result of SCG-0.50, doping with CuCl₂ further increases the dielectric constant. According to equation (1),

$${V}_{gap} = \frac{{σ}_{0} dx}{{ε}_{0} ( d + {ε}_{r} x )} \qquad ( 1 )$$

where σ₀ is charge density, d is the thickness of tribolayer, x is the gap distance, ε₀ is vacuum dielectric constant, and εᵣ is the relative dielectric constant of tribolayer, both surface potential and dielectric constant affect the electric output in assembled TENG.

### Example 50

### Performance of SCGC Film-Based Two-Electrode TENG

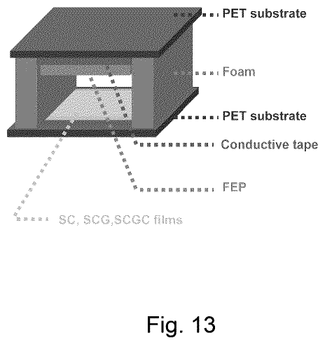

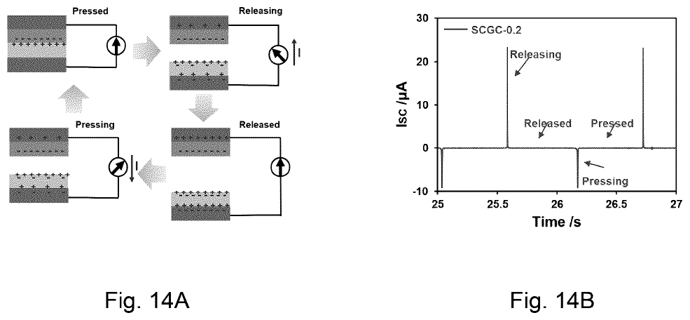

The impact of glycerol and CuCl₂ on the electric output was then evaluated at RH of 60% and 25° C. With reference to FIG. 13, FEP (2×2 cm²) was selected as the negative tribolayer, while SC, SCG, and SCGC films (2×2 cm²) were used as the positive tribolayer. The gap distance between the tribolayers is 10 mm, and the exerted speed and force are 0.2 m s⁻¹ and 12 N, respectively. As shown in FIGS. 14A and 14B, when the positive and negative tribolayers come in contact, electrons are transferred from the positive tribolayer to the negative tribolayer. Upon separation, positive charges are inducted on the negative electrode, and negative charges are inducted on the positive electrode, producing a current flow from the positive electrode to the negative electrode. As the positive and negative tribolayers come closer, opposite charges are inducted on the electrodes, and thus current flows from the negative electrode to the positive electrode.

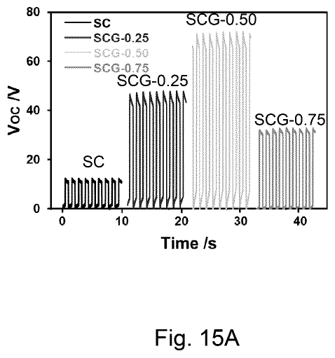

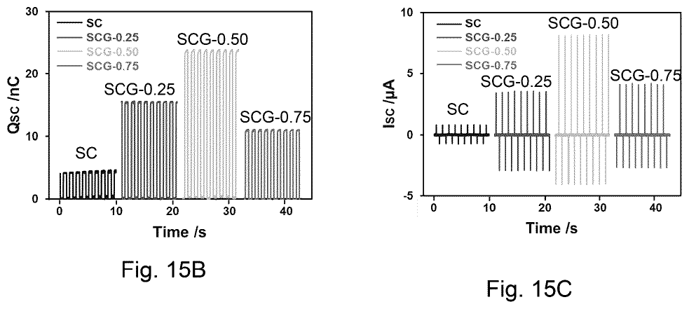

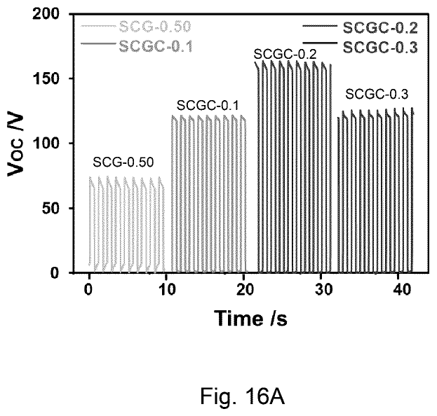

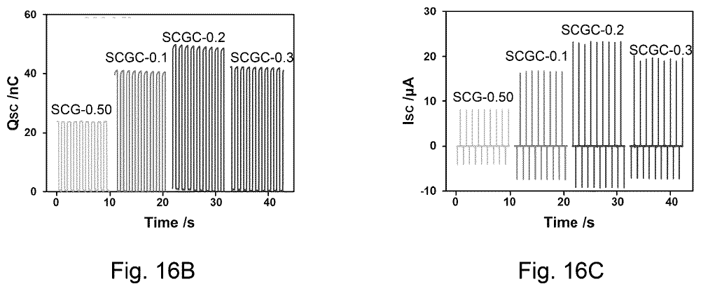

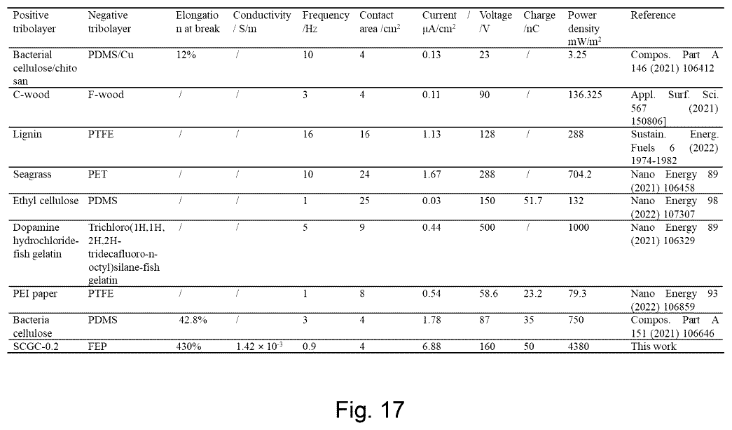

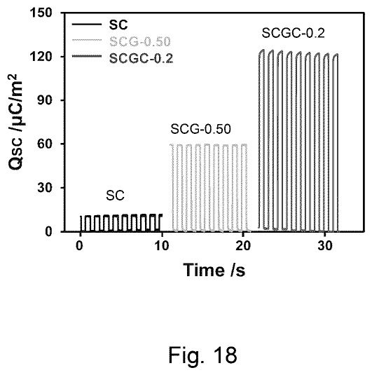

As shown in FIGS. 15A-15C, the samples which contain glycerol have higher electric output than pristine SC. While the V_{OC} and Q_{SC} of SCG-0.50 are 6 and 5.2-fold higher than SC (12 V, 4.6 nC), respectively, the I_{SC} of SCG-0.50 (8.2 μA) is 10.3-fold higher than SC (0.8 μA). Furthermore, the V_{OC} of 160 V, Q_{SC} of 50 nC and I_{SC} of 23 μA of SCGC-0.2-based two-electrode TENG (FIGS. 16A-16C) are higher than most reported biomass-based TENG (FIG. 17). In comparison with SC, SCGC-0.2-based TENG exhibits a 10.9-fold increase in Q_{SC} (125 μC m⁻²) (FIG. 18).

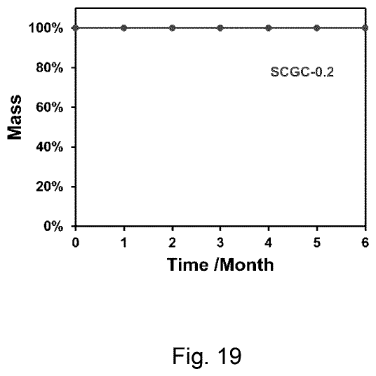

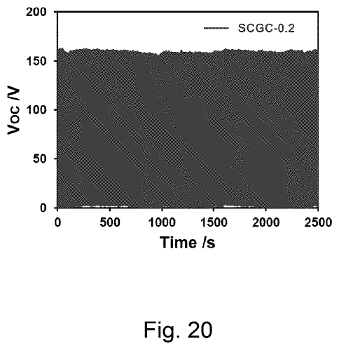

In addition, SCGC-0.2 retains 100% of its weight after 6-month storage in laboratory conditions (25° C. and 60% RH), without detectable water loss or decomposition (FIG. 19). After 2000 contact-separation cycles, the V_{OC} of SCGC-0.2-based TENG remains at 100% of the initial value, showing good stability (FIG. 20).

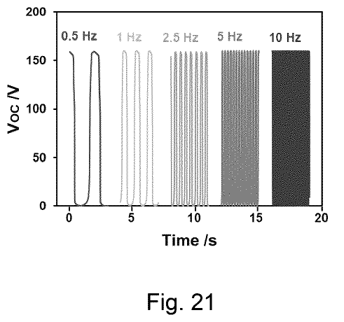

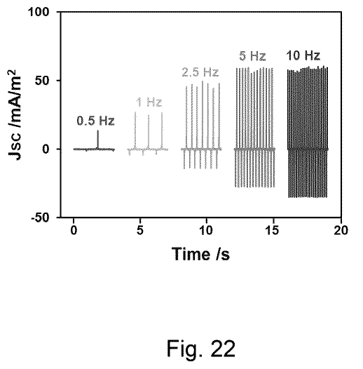

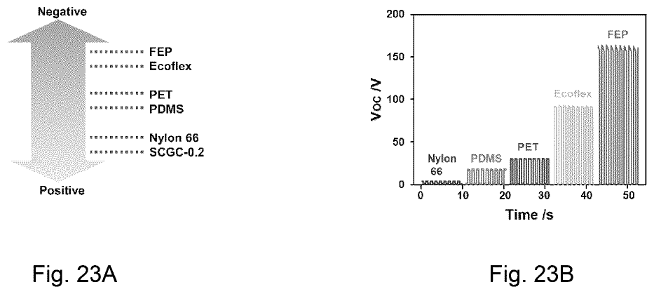

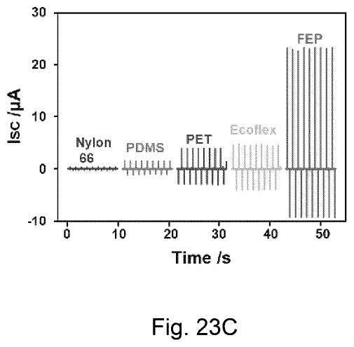

The working frequency of contact-separation represents a key factor affecting charge dissipation and current generation. As shown in FIG. 21, the V_{OC} keeps constant from 0.5 Hz to 10 Hz. Since current is negatively correlated with the spent time of each cycle (FIG. 22), current increases with increasing frequency. Particularly, the short-circuit current density (J_{SC}) reaches 68.8 mA m⁻², which is higher than the reported works (FIG. 17). As shown in FIGS. 23A-23C, SCGC-0.2 is a positive tribolayer, and by applying different negative tribolayers, different outputs are obtained and the optimal negative tribolayer is then selected. The surprisingly high electric output of Nylon 66 (the least negative material in the triboelectric series)-based device indicates excellent tribopositivity of SCGC-0.2.

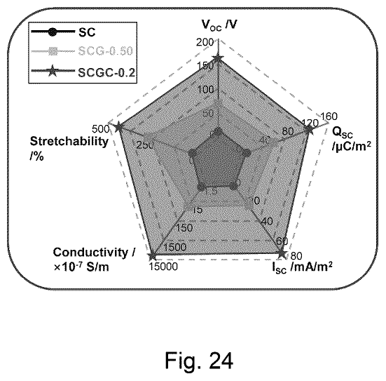

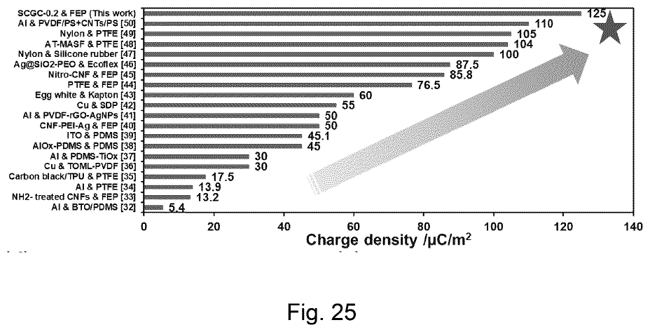

By trapping tribo-positive water molecules in SCGC-0.2, and chelating adjacent SC chains by CuCl₂, it is believed that the tribopositivity and mechanical properties of SCGC-0.2 are enhanced. As shown in FIG. 24, compared with SC and SCG-0.50, SCGC-0.2-based TENG shows enhanced stretchability, conductivity and electric output. Furthermore, as shown in FIG. 25, the SCGC-0.2-based TENG generates higher charge density (125 μC m⁻²) compared with the reported devices.

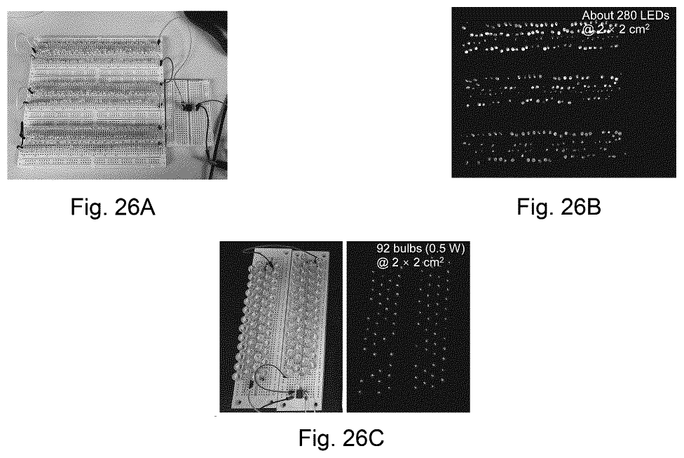

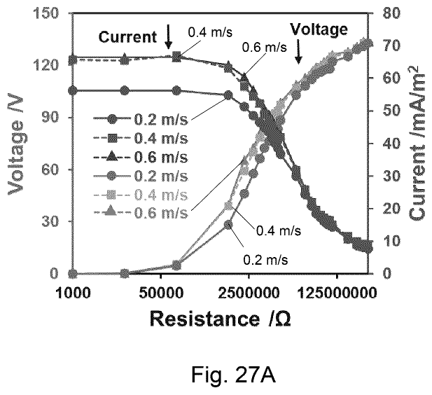

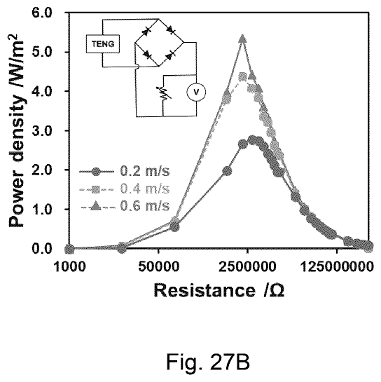

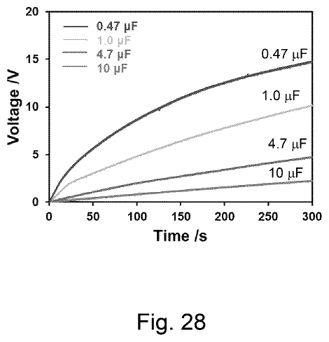

In an application as a power source, the SCGC-0.2-based two-electrode TENG lights up (powers) 280 LEDs and 92 bulbs (0.5 W) as demonstrated in FIGS. 26A-26C. To investigate the impact of load resistance, the SCGC-0.2-based device (2×2 cm²) was connected to resistors in parallel to measure voltage and in series to measure current. As shown in FIGS. 27A and 27B, when the load resistance increases, voltage increases while current decreases. According to Equation (2),

$$Power density = \frac{{V}^{2}}{R Area} \qquad ( 2 )$$

where V is the voltage, R is the load resistance and Area is the surface area of the tribolayer (2×2 cm²). The power density reaches 5.35 W m⁻² at 2 MΩ resistance and working speed of 0.6 m s⁻¹. With the increase of working speed from 0.2 to 0.6 m s⁻¹, the power density increases correspondingly. Given the high electric output, the SCGC-0.2-based device is used to power electronics and bulbs. As shown in FIG. 28, this device charges the capacitors of 0.47, 1, 4.7 and F to 14.8, 10.2, 4.7 and 2.2 V within 300 s.

### Example 51

### Performance of SCGC Film-Based One-Electrode TENG

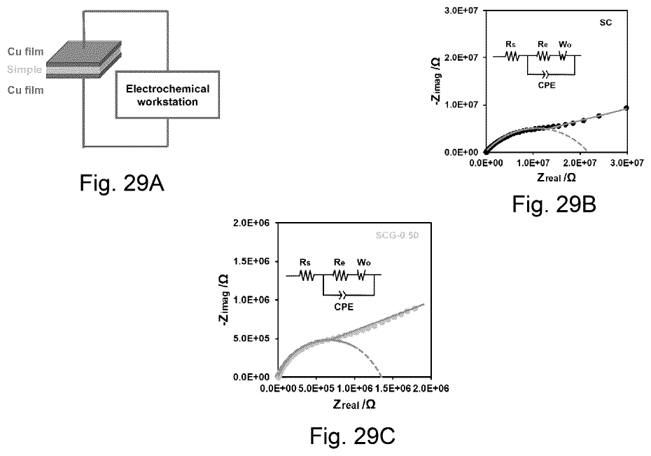

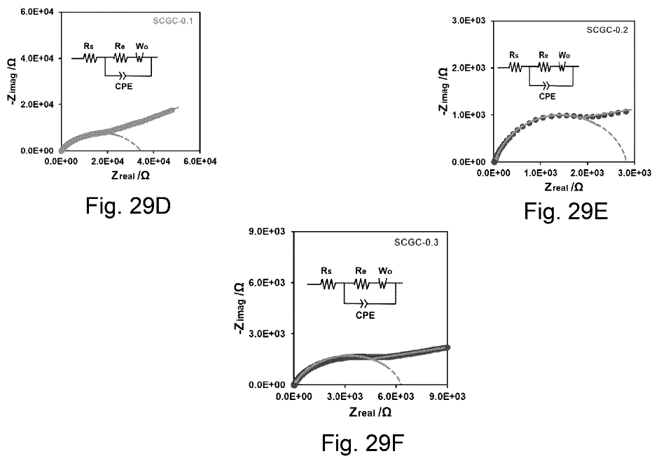

As mentioned, there might be risk of delamination of tribolayer from electrode. Developing materials which can function as tribolayer and electrode simultaneously is therefore believed to be a promising strategy. Without wishing to be bound by theory, it is believed that ionic conductivity represents an important factor to consider. As shown in FIGS. 29A-29F, the films were inserted between two Cu foils for ionic conductivity measurement at RH of 60% and 25° C. According to Equation (3),

$$Ionic conductivity = \frac{L}{{R}^{′} Area} \qquad ( 3 )$$

where L is the thickness of the film (0.4 mm), R′ is the resistance and Area is the surface area of the electrode (1×1 cm²).

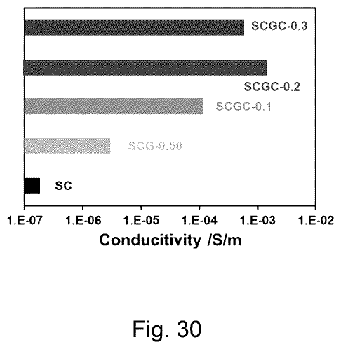

Compared with SC (1.86×10⁻⁷ S m⁻¹), the ionic conductivity of SCG-0.50 and SCGC-0.2 is enhanced to 2.9×10⁻⁶ S m⁻¹ and 1.4×10⁻³ S m⁻¹, respectively (FIG. 30). Despite the presence of Na⁺ in SC, its ionic mobility is limited due to the lack of a solvating medium. On the other hand, SCG-0.50 contains glycerol and absorbed water, which form solvating media for Na⁺, resulting in enhancement in ionic conductivity. Furthermore, Cu²⁺ displaces Na⁺ in SCGC films and forms a chelate, leading to weaker electrostatic forces between Na⁺ and —COO⁻. In addition, a chelate has a micro-net structure, which is believed to be beneficial for facilitating ion mobility.

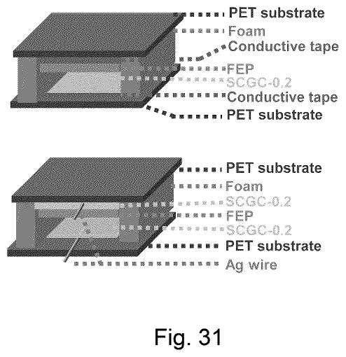

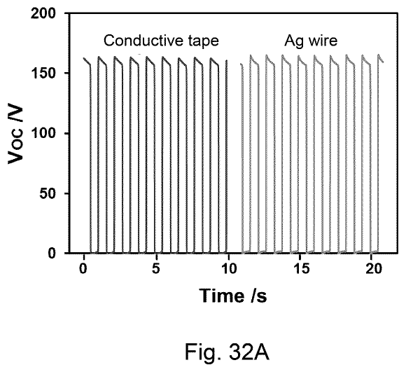

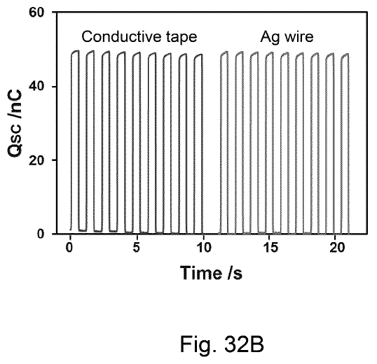

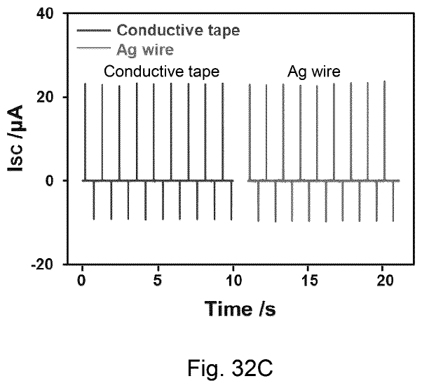

Owing to higher ionic conductivity, SCGC-0.2 may be configured to act as a positive tribolayer and electrode simultaneously as shown in FIG. 31. Compared to the device, where SCGC-0.2 acts as a positive tribolayer only and using a conductive tape as electrode, a similar electric output was observed when the SCGC-0.2 acts both the positive tribolayer and electrode simultaneously (FIGS. 32A-32C).

### Example 52

### Applications of SCGC Film-Based TENGs

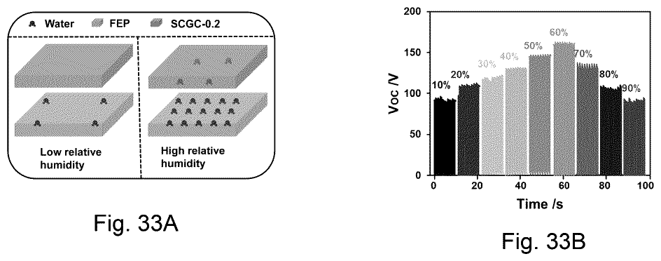

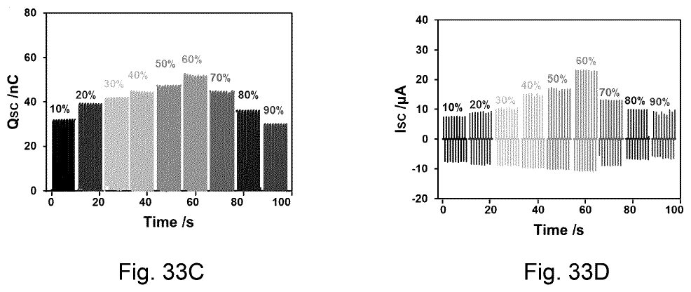

It is believed that the TENG of the present invention is suitable for the monitoring RH. Thus, the TENG was examined under the testing condition of 25° C. in air. As RH increases, the amount of retained water by glycerol increases, affecting the electric output. When RH is low, less water is absorbed resulting in a decrease of the tribopositivity of SCGC-0.2. In contrast, when the tribolayers contact at high RH, excessive water adheres to the FEP counterpart, leading to decrease of electric output (FIG. 33A). As shown in FIGS. 33B-33D, the electric output reaches a maximum at 60% RH and then decreases with further increase of RH.

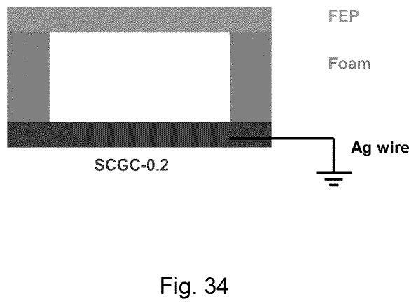

It is also believed that the TENG of the present invention may efficiently harvest kinetic energy and may be used for monitoring human body motions. FEP, as the flexible negative tribolayer, and SCGC-0.2, as the flexible positive tribolayer and electrode, are separated by two pieces of foam with a gap distance of 5 mm (FIG. 34). An Ag wire was connected to SCGC-0.2 for electric output measurement.

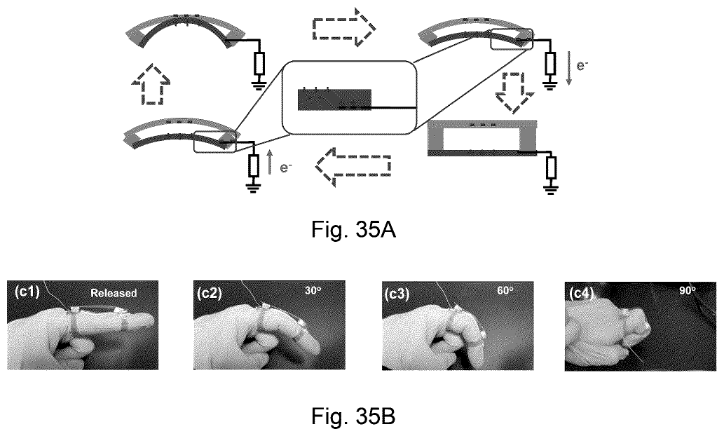

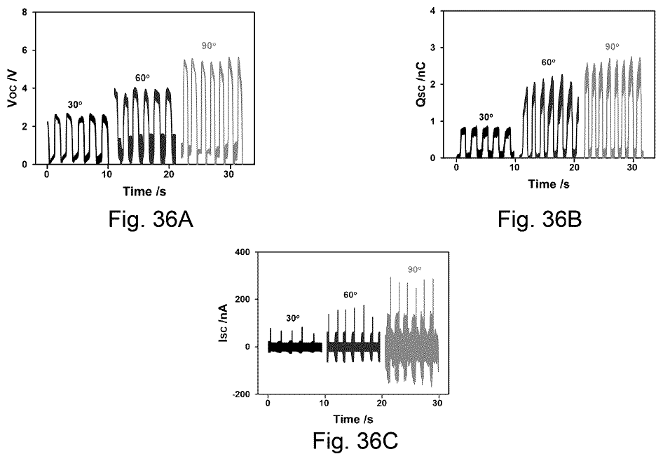

In operation, this single electrode TENG was tied on a glove. When a finger is bent, SCGC-0.2 contacts FEP, and electrons are transferred from SCGC-0.2 to FEP. When the finger is released, electrons are transferred from the ground to Ag wire (FIG. 35A). As shown in FIG. 35B, the bending angles of this device are from 30° to 90° at RH of 60% and 25° C. With the increase of bending angle, the voltage increases from 2.3 to 5.7 V and the current increases from 80 to 280 nA (FIGS. 36A-36C).

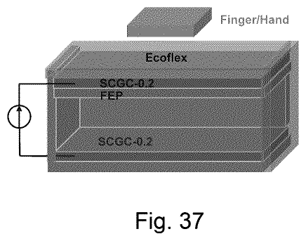

As shown in FIG. 37, a multilayer TENG may be configured. The multilayer TENG may be consists of five flexible layers, from top to bottom; Ecoflex as encapsulation material and negative tribolayer, SCGC-0.2 as the negative electrode, FEP as negative tribolayer, SCGC-0.2 as positive tribolayer and electrode, and Ecoflex as encapsulation material. A gap distance of 3 mm is created between FEP and SCGC-0.2.

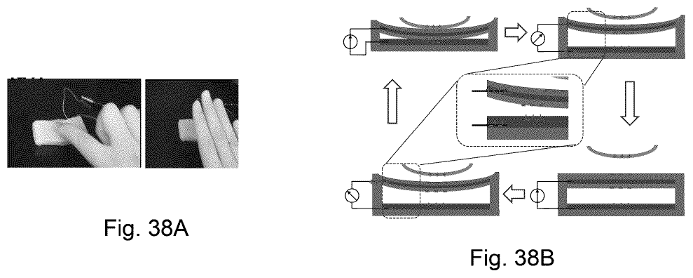

As shown in FIGS. 38A and 38B, when force is exerted on the device, a finger or hand acting as a positive tribolayer contacts Ecoflex, and thus electrons transfer from skin to Ecoflex. The common tapping force is generally enough to make FEP and SCGC-0.2 come into contact. In this case, at each tapping-releasing cycle, charge transfer process occurs from two group tribolayers: skin and Ecoflex, and FEP and SCGC-0.2. When the finger/hand is released, positive charges are induced on SCGC-0.2 and negative charges are induced on the bottom SCGC-0.2. Simultaneously, an electric double layer is formed between SCGC-0.2 and Ag wire, and electricity is generated in the external circuit.

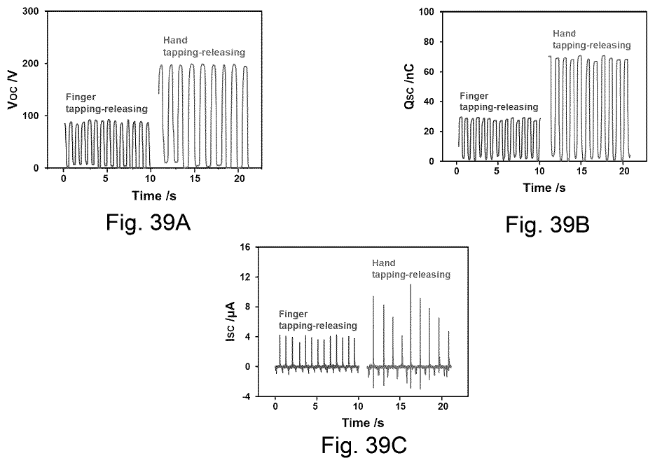

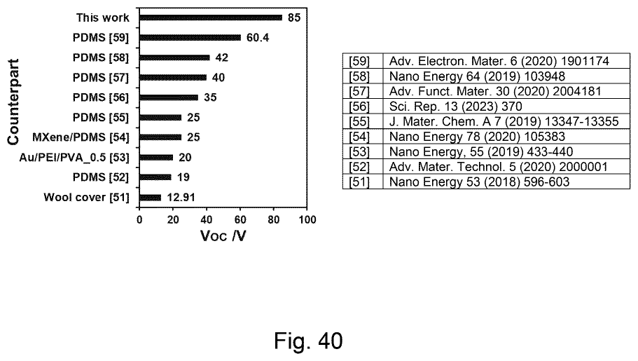

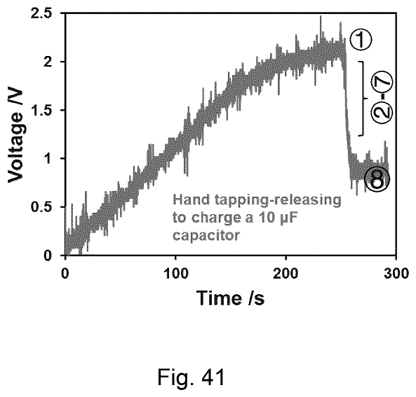

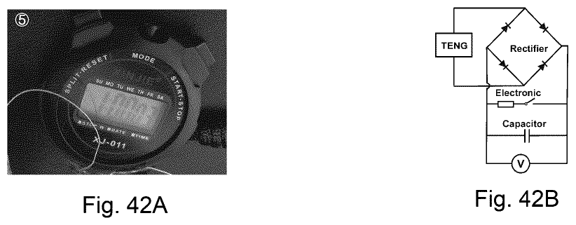

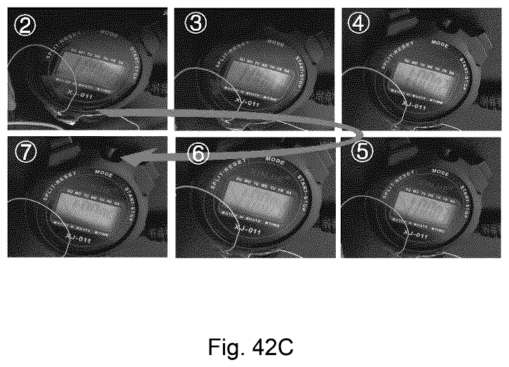

As shown in FIGS. 39A-39C, at RH of 60% and 25° C., when the device is tapped with a thumb, the V_{OC}, Q_{SC} and I_{SC} reach 85 V, 29 nC and 4 μA, respectively, while hand tapping yields 200 V, 70 nC, 8 μA, higher than the electric output of most finger tapping devices (FIG. 40). Due to the large electric output, a 10 μF of capacitor was connected to a rectifier and charged by via hand tapping-releasing. As shown in FIG. 41, the voltage of the 10 μF capacitor increased to 2.3 V after charging for 250 s, which can be used as a power source of a stopwatch (FIGS. 42A-42C).

The invention has been given by way of example only, and various other modifications of and/or alterations to the described embodiment may be made by persons skilled in the art without departing from the scope of the invention as specified in the appended claims.

1. A material for triboelectric nanogenerator comprising a biomass-based material co-doped with a hygroscopic agent and a metal salt, wherein:
the biomass-based material includes any one of a saccharide-based material;
the hygroscopic agent includes any one of a polyol-based compound, a sulfone-based compound, a tetrahydropyran-based, or a isocyanate-based compound; and
the metal salt includes any one of a monovalent metal salt, a divalent metal salt or a trivalent metal salt.

2. The material as claimed in claim 1, wherein the saccharide-based material comprises sodium alginate, lignin, cellulose, starch, sodium lignosulfonate, sodium carboxymethylcellulose, Arabic gum, maltose, glucose, natural resin, and chitin.

3. The material as claimed in claim 2, wherein the natural resin includes polyurethane resin and acrylic resin.

4. The material as claimed in claim 1, wherein the hygroscopic agent includes at least one of: 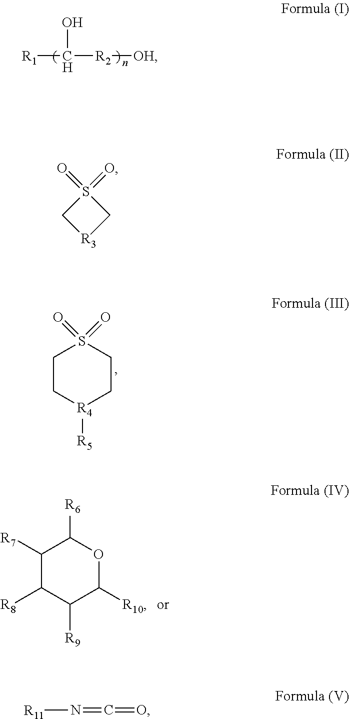
wherein:
n is positive integer;
R₁ and R₂ are independently selected from hydrogen, an alkyl group, hydroxyl group, hydroxyalkyl group, carbonyl group, alkylcarbonyl group, sulfhydryl group, or amino group;
R₃ is selected from an alkyl group, alkoxy group, hydroxyalkyl group, alkylmercapto group, alkylamino group, or alkyl sulfone group, with 1-10 carbon atoms;
R₄ is a nitrogen or sulfur element;
R₅ is a hydroxyl group, sulfhydryl group or amino group;
R₆, R₇, R₈, R₉ and R₁₀ are independently selected from an alkyl group, hydroxyl group, hydroxyalkyl group, a sulfhydryl group or an amino group, with 1-10 carbon atoms; and
R₁₁ is selected from an alkyl group, hydroxyl group, hydroxyalkyl group, isocyanate, alkyl isocyanate, sulfhydryl group or amino group, with 1-10 carbon atoms.

5. The material as claimed in claim 4, wherein the hygroscopic agent of Formula (I) is selected from the group consisting of glycerol, ethylene glycol, butylene glycol, glyoxylic acid monohydrate and a combination thereof.

6. The material as claimed in claim 4, wherein the hygroscopic agent of Formula (II) and Formula (III) are selected from the group consisting of: 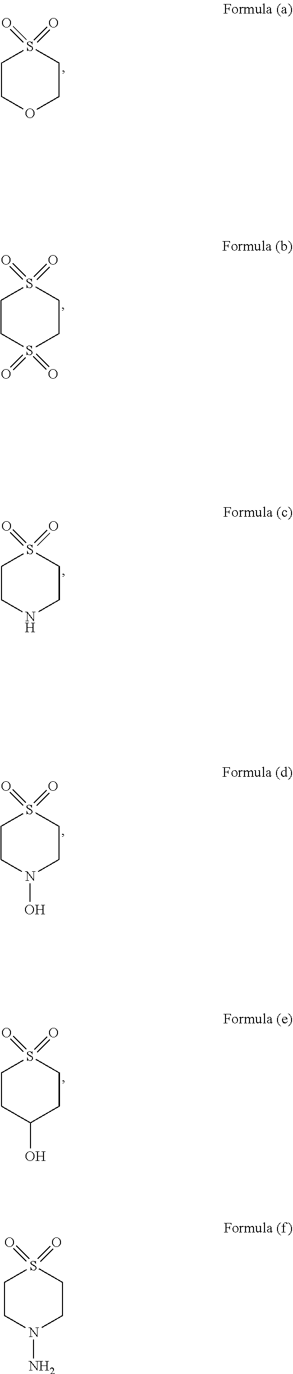 [SMILES: O=S1(=O)CCOCC1 ; O=S1(=O)CCS(=O)(=O)CC1 ; O=S1(=O)CCNCC1 ; O=S1(=O)CCN(O)CC1 ; O=S1(=O)CCC(O)CC1 ; NN1CCS(=O)(=O)CC1]
and a combination thereof.

7. The material as claimed in claim 4, wherein the hygroscopic agent of Formula (IV) is selected from the group consisting of: 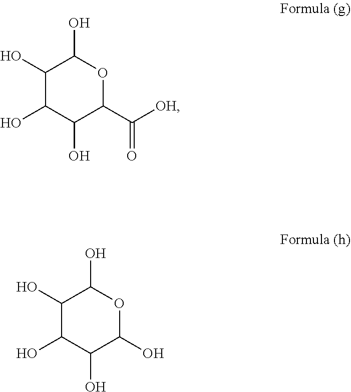 [SMILES: O=C(O)C1OC(O)C(O)C(O)C1O ; OC1OC(O)C(O)C(O)C1O]
and a combination thereof.

8. The material as claimed in claim 4, wherein the hygroscopic agent of Formula (V) is selected from the group consisting of: 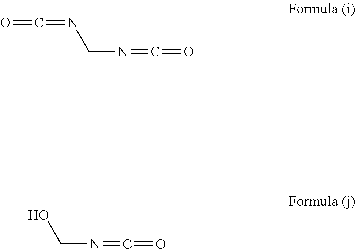 [SMILES: O=C=NCN=C=O ; O=C=NCO]
and a combination thereof.

9. The material as claimed in claim 1, wherein weight ratio of the hygroscopic agent to the biomass-based material is from about 1:5 to about 2:1.

10. The material as claimed in claim 1, wherein the metal salt includes halide, nitrate, sulfate, carbonate, sulfite, hydroxide, borate, oxalate, difluorooxalatoborate, bisoxalate borate, phosphate, fluorosulfonimide, alkylfluorosulfonimide, sulfonate, alginate, lignosulfonate or carboxymethyl cellulose of lithium, calcium, iron(II), iron(III), copper(II), cobalt(II) or zinc(II).

11. The material as claimed in claim 10, wherein the metal salt is selected from any one of zinc(II) bisoxalate borate, lithium bisoxalate borate, zinc(II) dimethylfluorosulfonimide, lithium dimethylfluorosulfonimide, calcium chloride, copper(II) chloride, zinc(II) chloride, cobalt(II) chloride, iron(III) chloride, iron(II) sulfate, copper(II) sulfate or zinc(II) sulfate.

12. The material as claim 1, wherein weight ratio of the metal salt to the biomass-based material is from about 1:100 to about 1:25.

13. The material as claimed in claim 1, wherein the biomass-based material is selected from the group consisting of sodium alginate, sodium lignosulfonate, sodium carboxymethylcellulose and a combination thereof; the hygroscopic agent is selected from the group consisting of glycerol, glyoxylic acid monohydrate, Formula (c), Formula (e), Formula (f), Formula (g), Formula (h), Formula (i), Formula (j) and a combination thereof; the metal salt is selected from the group consisting of zinc(II) chloride, copper(II) chloride and a combination thereof.

14. The material as claimed in claim 13, wherein the biomass-based material is sodium alginate or sodium lignosulfonate; the hygroscopic agent is selected from the group consisting of glyoxylic acid monohydrate, Formula (c), Formula (e), Formula (f), Formula (g), Formula (h), Formula (i), Formula (j) and a combination thereof; the metal salt is zinc(II) chloride or copper(II) chloride.

15. The material as claimed in claim 13, wherein the biomass-based material is sodium carboxymethylcellulose; the hygroscopic agent is glycerol; and the metal salt is copper(II) chloride.

16. The material as claimed in claim 1 is a tribo-positive material.

17. A triboelectric nanogenerator comprising:
a first member including a tribo-positive layer of the material as claimed in claim 1 and a positive electrode;
a second member including a tribo-negative layer and a negative electrode;
the first and second members are spatially separated from one another thereby permits relative movement of the first member and the second member for generating a potential difference between them as a result of triboelectrification effect.

18. The triboelectric nanogenerator as claimed in claim 17 further comprising a separating member configured to maintain the spatial separation between the first member and the second member.

19. The triboelectric nanogenerator as claimed in claim 18, wherein the separating member is deformable.

20. The triboelectric nanogenerator as claimed in claim 19, wherein the separating member includes any one of foam, rubber or spring.

21. The triboelectric nanogenerator as claimed in claim 17, wherein the tribo-negative layer includes any one of polytetrafluoroethylene, fluorinated ethylene propylene, silicon rubber, polydimethylsiloxane, polyvinyl chloride, or polyvinyl alcohol.

22. The triboelectric nanogenerator as claimed in claim 17 further comprising a first substrate and a second substrate to each of which the first member and the second member are attached.

23. The triboelectric nanogenerator as claimed in claim 22, wherein the second substrate is configured to act as another tribo-negative layer thereby permits charge transfer to occur between the second substrate and a standalone tribo-positive material.

24. The triboelectric nanogenerator as claimed in claim 23, wherein the standalone tribo-positive material includes a body part of a living subject.

25. The triboelectric nanogenerator as claimed in claim 22, wherein the first substrate and the second substrate are integrated to form an encapsulation encapsulating the triboelectric nanogenerator.

26. The triboelectric nanogenerator as claimed in claim 22, wherein the first substrate and the second substrate include any one of polyethylene terephthalate or silicon rubber.

27. The triboelectric nanogenerator as claimed in claim 17, wherein the positive electrode and the negative electrode have different materials.

28. The triboelectric nanogenerator as claimed in claim 27, wherein the positive electrode has the same material as the tribo-positive layer and is integrated with the tribo-positive layer to form a single layer.

29. The triboelectric nanogenerator as claimed in claim 27, wherein the negative electrode has the same material as the tribo-negative layer and is integrated with the tribo-negative layer to form a single layer.

30. The triboelectric nanogenerator as claimed in claim 17, wherein the positive electrode and the negative electrode have the same material.

31. The triboelectric nanogenerator as claimed in claim 31, wherein the positive electrode and the negative electrode include Ni/Ag conductive tape.

32. The triboelectric nanogenerator as claimed in claim 30, wherein the positive electrode and the negative electrode have the same material as the tribo-positive layer.

33. The triboelectric nanogenerator as claimed in claim 32, wherein the positive electrode is integrated with the tribo-positive layer to form a single layer.

34. The triboelectric nanogenerator as claimed in claim 17, wherein the spatial separation between the first member and the second member is from about 3 mm to about 10 mm.

35. The triboelectric nanogenerator as claimed in claim 17 is bendable away from a horizontal plane by about 30° to about 90°.
